(19) United States
(12) Patent Application Publication
(10) Pub. No.: US 2026/0065530 A1
(43) Pub. Date: Mar. 5, 2026

(54) SYSTEM AND METHOD FOR PERFORMING COLOR CORRECTION OF INDIVIDUAL DISPLAY ELEMENTS IN A VIRTUAL STUDIO

(71) Applicant: Disney Enterprises, Inc., Burbank, CA (US)

(72) Inventors: Eliza McNair, Burbank, CA (US); Daniel Boehning, Burbank, CA (US); Rachel Mainville, Burbank, CA (US); Mark Medaglia, Burbank, CA (US); Erik Barone, Burbank, CA (US)

(21) Appl. No.: 18/819,876

(22) Filed: Aug. 29, 2024

(51) Int. Cl. G06T 11/00; A63F 13/50; H04N 5/222; H04N 9/64

(52) U.S. Cl. CPC G06T 11/10; A63F 13/50; H04N 5/2224; H04N 9/64; G06T 2200/24

(57) ABSTRACT

A system and method to perform color correction of at least one virtual screen image displayed on a portion of a virtual background scene in a virtual studio while not altering the color of the background scene, includes providing an RGB virtual screen image having RGB components with RGB component values, displaying on a user device, a plurality of selectable color correction parameters and a range of values for each of the selectable color correction parameters, and at least one selectable virtual screen image corresponding to the color correction parameters, receiving from a user a selection of a value for at least one of the selectable color correction parameters corresponding to a selected virtual screen image as selected color correction parameter values, and adjusting the values of the RGB components of the RGB virtual screen image based on the selected color correction parameter values as a color adjusted virtual screen image.

### BACKGROUND

Traditional broadcast studios typically have video monitors located in the studio which are used to display graphics, stats, images, video clips and the like to enhance the viewing experience for the viewer. The images shown on such monitors typically need to be adjusted by operators or “color shaders” to provide proper “shading” or color correction to ensure the images on the monitors match the intended images. Such monitor shading (or color adjustments or color correction) may use hardware, such as, for example, an Evertz Model 2430RX-J2K-IP, JPEG2000 to HDMI/DVI/DisplayPort processing converter, which decodes, processes, color corrects and converts the output to a DVI/HDMI signal to be displayed on a DVI/HDMI studio monitor. This hardware (each instance sometimes referred to as a “puck”) is installed in control rooms and are adjusted by the operators (or “video shaders”) who control manual inputs that adjust the color characteristics such as chrominance (or chroma or saturation) and luma (or brightness) of the overall color output of rendered graphics displayed on physical monitors in studio by tuning various hardware and software filters contained in the “pucks” to alter the color characteristics of the output.

Modern “virtual studios” include physical studios where the walls and floor are lined with LED tiles or panels or displays, with a predetermined number of LED pixels per panel (or resolution or pitch), which are designed and installed to appear to be seamless single surfaces or LED volume. The LED tile-covered walls and floors (or LED volume) of these virtual studios may be filmed using a traditional broadcast video camera to give the impression that the live talent personnel in the virtual studio are inhabiting a physical environment that has in fact been created all virtually via graphics displayed by illuminating the LED tiles. It may be useful from time to time to have a portion of the virtual studio being displayed on the LED tiles include virtual screens or virtual video monitors, similar in appearance to physical monitors in traditional studios. Such virtual screens are graphics (or videos) displayed on the LED wall tiles that make it appear as if there are separate physical video monitors in the virtual studio environment for the talent to interact with. These virtual video monitors can display graphics and play video just as if there were additional physical video monitors in the studio.

The LED panels of the virtual studio may be driven (or illuminated) by virtual studio production tools which may include a known 3D computer graphics or game engine, such as the Unreal Engine®, made by Epic Games, Inc., which include features such as Unreal Materials Editor which allow developers or operators to customize incoming “textures” (of the images or videos) by modifying color correction (or color adjustment) parameters including roughness, metallic, specular, and others.

Additionally, the Unreal Engine offers shading control over the LED Volume, which impacts the global scene (or studio backdrop or background scene or virtual set). However, for a broadcast virtual production workflow, there is an additional requirement of color correcting incoming contents (images and videos) that populate the virtual video monitors or virtual screens in the virtual studio space.

For best results, the content displayed by the virtual monitors must be color controlled or corrected separately from the other (or background) graphics that make up the virtual set. This is because the content on the virtual monitors is sourced outside the system that provides the graphics for the virtual sets. This additional level of control requires not only global scenic control of the virtual monitors, but also granular control to individual scene components of the virtual monitors by monitor and by location.

Due to the time pressure of video operations for live television, the demand of matching team and franchise brand colors exactly, and the fact that graphics engines, such as the Unreal Material Editor, do not provide an off-the-shelf, broadcast ready solution for color correcting such virtual screens/monitors, a solution is needed which maintains the features of the existing graphics engine while providing an easy to use, broadcast compatible toolset for color correcting such virtual monitors in a virtual studio set.

Thus, it would be desirable to have a system and method that overcomes the shortcoming of the current virtual studio production tools and that allows users or color shaders or video operators to color correct or adjust the components of the colors on the virtual screens as though they were separate physical studio monitors.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a top-level block diagram showing components of a system and method to perform color correction of individual display elements in a virtual studio, in accordance with embodiments of the present disclosure.

FIG. 1B is a portion of the diagram of FIG. 1A showing an embodiment using a projection system in the physical studio, in accordance with embodiments of the present disclosure.

FIG. 1C is a top-level block diagram of the system of FIG. 1A and FIG. 1B having a plurality of user/operators and a plurality of user devices, in accordance with embodiments of the present disclosure.

FIG. 2A is a screen illustration of a user interface (UI) for a color correction application on a user device of FIG. 1A, in accordance with embodiments of the present disclosure.

FIG. 2B shows tables for color correction UI parameters and a sequence for processing UI input data, in accordance with embodiments of the present disclosure.

FIG. 3A is a top-level data flow diagram for Color Correction Logic of FIG. 1A, in accordance with embodiments of the present disclosure.

FIG. 3B is a data flow diagram for RBG Color Grating Logic of FIG. 3A, in accordance with embodiments of the present disclosure.

FIG. 3C is a data flow diagram Chroma Logic of FIG. 3A, in accordance with embodiments of the present disclosure.

FIG. 3D is a data flow diagram VideoLevel Logic of FIG. 3A, in accordance with embodiments of the present disclosure.

FIG. 3E is a data flow diagram BlackLevel Logic of FIG. 3A, in accordance with embodiments of the present disclosure.

FIG. 3F is a data flow diagram Hue Logic of FIG. 3A, in accordance with embodiments of the present disclosure.

FIG. 4A is a Color Correction Parameters Table, showing parameters that may be set for performing the Color Correction Logic of FIG. 1A, in accordance with embodiments of the present disclosure.

FIG. 4B, FIG. 4C, and FIG. 4D are tables showing data files that may be saved and retrieved for Virtual Sets, Test Patterns, and Color Presets, respectively, in accordance with embodiments of the present disclosure.

FIG. 5A is an illustration of a broadcast image having a baseball field virtual set image and three virtual monitors and live talent, in accordance with embodiments of the present disclosure.

FIG. 5B, FIG. 5C, and FIG. 5D are color images of the raw virtual screen image, the RGB video feed image, and the color corrected CC RGB image, respectively, in accordance with embodiments of the present disclosure.

FIG. 6A, FIG. 6B, and FIG. 6C are color images of the test patterns, in accordance with embodiments of the present disclosure.

FIG. 6D and FIG. 6E, are waveform monitor images of a gray scale test pattern (Grayscale Percent Ramp) before and after color correction, respectively, with an inset image of the studio output, in accordance with embodiments of the present disclosure.

FIG. 6F and FIG. 6G, are vectorscope images of a color bar test pattern (Color Bars Rec. 709) before and after color correction, respectively, with an inset image of the studio output, in accordance with embodiments of the present disclosure.

FIG. 7A is a flow diagram of an embodiment of a Color Correction App/UI Logic (per user), in accordance with embodiments of the present disclosure.

FIG. 7B is a flow diagram of an embodiment of a Color Correction Logic, in accordance with embodiments of the present disclosure.

FIG. 7C is a flow diagram of an embodiment of API/Data Broker Logic, in accordance with embodiments of the present disclosure.

FIG. 8 is a block diagram of various components of the system of FIG. 1A FIG. 1B, and FIG. 1C, connected via a network, in accordance with embodiments of the present disclosure.

### DETAILED DESCRIPTION

As discussed in more detail below, in some embodiments, the present disclosure is directed to a system and method to perform color correction of individual virtual display elements (or virtual screens or virtual video monitors) in a virtual studio, such as an LED or projection-based virtual studio, or other virtual studio display screen technology, which allows an operator (or color shader) full color control of each individual virtual screen in the virtual studio while not altering the virtual background scene (or virtual set image). The system and method of the present disclosure may also include a color correction App (or CC App) having a user interface or WebUI running on a user device that allows a user (or operator) to perform color correction of the virtual monitors as though they were separate physical studio monitors and allows the user to see the resulting color corrected image being broadcast. The system and method of the present disclosure includes a color correction plug-in (or CC Plug in) which may be installed as a plug-in (or an add-on) to known a graphics engine used to drive the images displayed in the virtual studio.

As described above, video graphics engines, such as the Unreal Engine described above, can provide uniform color correction for the entire virtual studio as a unit, but cannot provide independent color correction for individual areas/virtual components in the virtual studio, such as the content displayed via the virtual monitors or virtual screens (VS1-VSN). The system and method of the present disclosure provides a tool which condenses color math, conversion formulas, and linear/quadratic equations into sub-functions that run as a separate program or plug-in within the overall graphics engine, e.g., Unreal's Material Editor. These background processes allow operators to make color adjustments or color correction of a selected virtual screen/monitor in realtime through the web interface or UI of the present disclosure without altering the color of the rest of the virtual studio.

The color correction system of the present disclosure allows video operators to interface with virtual screens as though they were physical studio monitors. This avoids the need for additional graphics engine programming personnel being required on-site for every virtual production shoot, and instead prioritizes the knowledge and expertise possessed by operations staff. This is different from a purely graphics engine-based solution which would require graphics engine programmers to make changes to the graphics engine during production. Thus, the present disclosure streamlines video shoots and avoids additional staffing requirements.

The system of the present disclosure provides a new solution which meets the need for color correction solution for broadcast virtual production that translates color correction control parameters from an operator input to adjust the color parameters from a graphics engine. The present disclosure may be used in any application, including non-broadcast environments, that typically use hardware driven color correction solutions that is desired to move into a virtual development space. Further, the color correction logic/model could be applied to material properties in other real-time rendering engines (e.g., Unity, Vizrt, etc.).

The present disclosure allows the user/operator to ensure that the brightness and color of images displayed on the virtual screens/monitors are properly balanced as well as maintain (or meet or comply with) any required color specifications, such as logo colors, trademark/branding specifications, or required legal/regulatory specifications such as FCC regulations and the like.

The system and method of the present disclosure also includes a color correction app (or CC App) having a user interface (UI) or webUI running on a user device that allows a user (or operator) to perform color correction of virtual monitors as though they were separate physical studio monitors and allows the user to see the resulting color corrected image being broadcast. The system and method of the present disclosure may also include a Color Correction Logic (or CC Plug in), which may be installed as a plug-in (or an add-on) to known graphics engine logic used to drive the video in a virtual studio, as discussed herein.

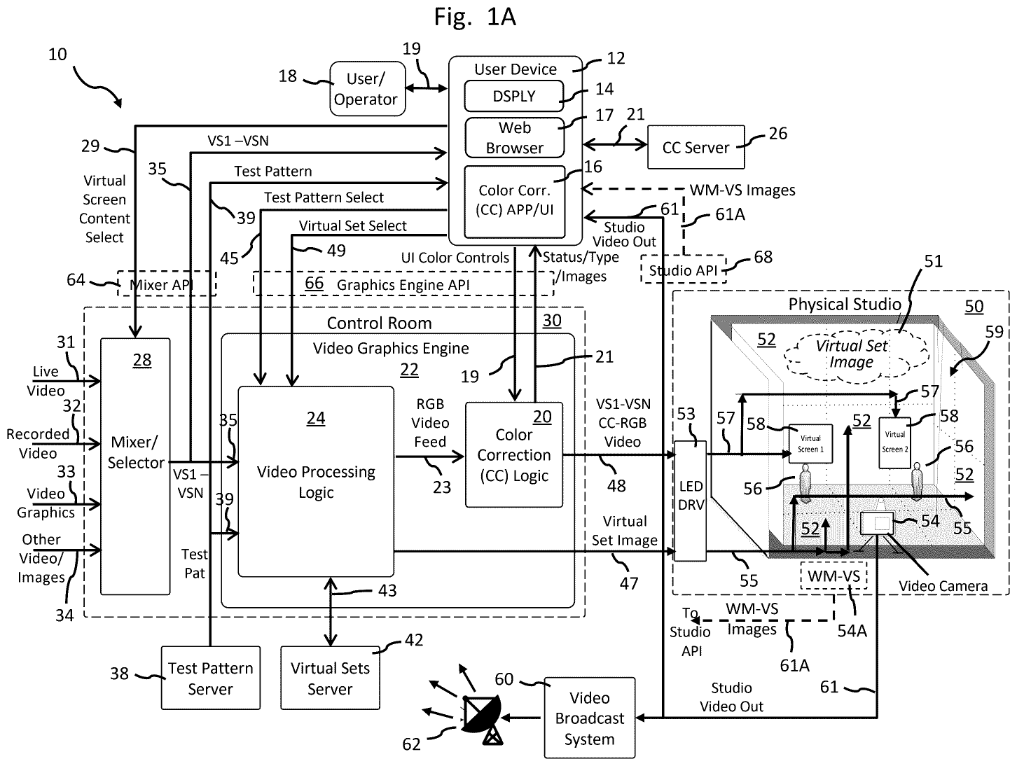

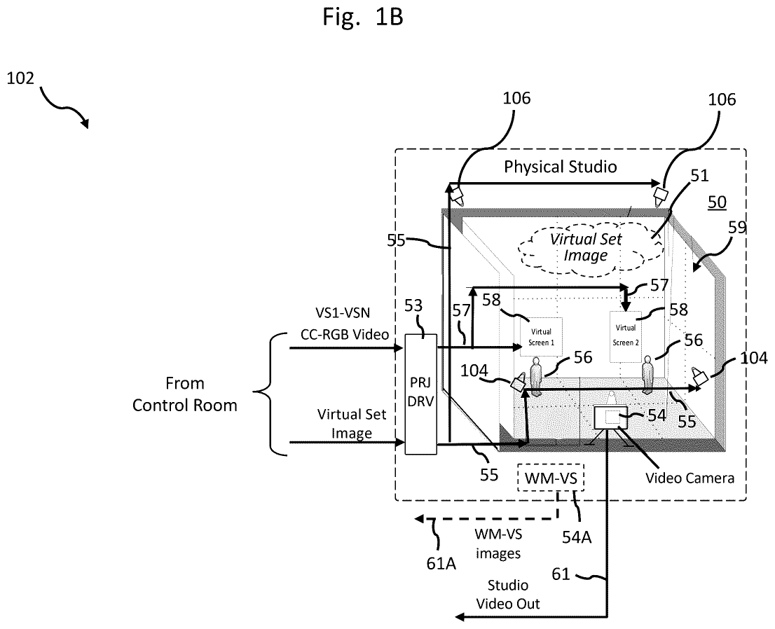

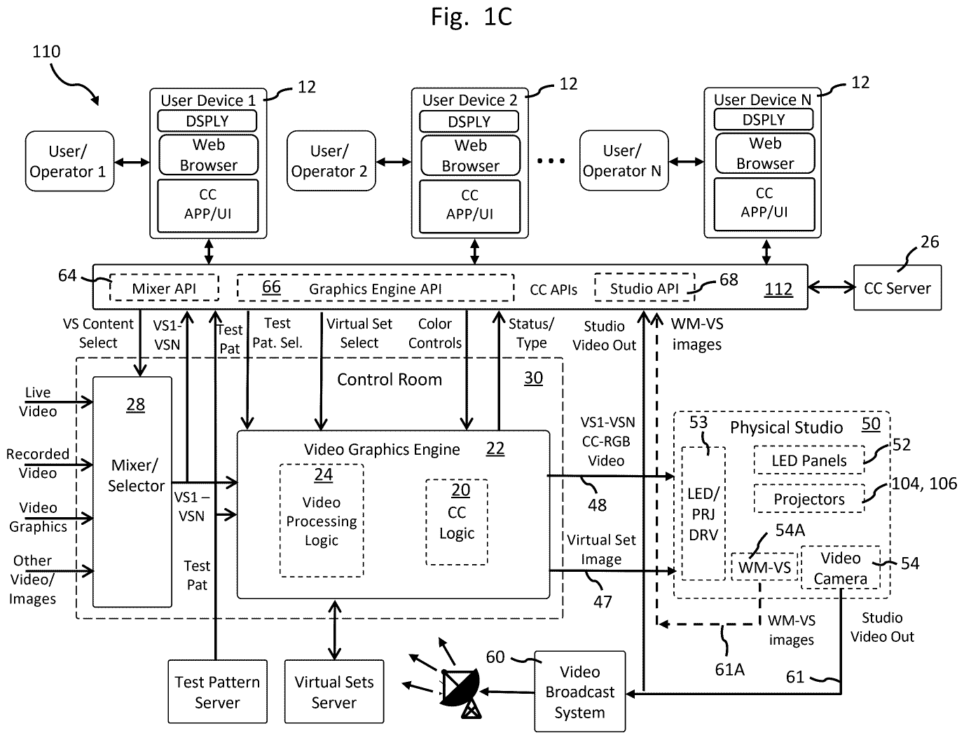

Referring to FIG. 1A, various components (or devices or logic) of a system 10 are shown for a system and method to perform color correction (or control) of individual display elements (or screens or video monitors) in a virtual studio, such as an LED-tiled virtual studio, in accordance with embodiments of the present disclosure. The system 10 includes at least one user device 12, such as a desk top computer, laptop computer, smart phone or other computer-based device, having a Color-Correction (CC) App/UI 16 and may include a web browser 17 (depending on the network environment/configuration) loaded thereon, and a display 18. In some embodiments, the user device 12 may communicate with other devices and system components via other networks/devices, such as Bluetooth, Wi-Fi, or other network interface. The user device 12 communicates with and receives input commands from a user (or operator or color shader) 18, as shown by a line 19. The user device 12 receives commands from the user 18 while the device 12 is running the CC App 16 and provides a user interface (UI) to the display 14 for interaction with the user 18.

The user device 12 also provides output commands on a line 19 to Color Correction Logic (or CC Plug in) 20 and receives status/type/image data on a line 21 from the Color Correction Logic 20. The Color Correction Logic (or CC Plug in) 20 may be installed as a plug-in (or an add-on) to a known graphics engine 22, e.g., the Unreal Engine, used to drive the video images shown in a virtual studio environment, discussed more hereinafter. The video graphics engine 22 may include video processing logic 24 which communicates with the Color Correction (CC) Logic (or CC Plug in) 20 on a line 23, as discussed more herein.

The user device 12 also communicates with a color correction server 26 on a line 27 to retrieve and store data relating to color correction as discussed herein. The user device 12 also provides a virtual screen content selection command to a mixer/selector 28 on a line 29, discussed hereinafter. The mixer/selector 28 and the video graphics engine 22 may be housed within a studio control room 30, which provides video and graphics (collectively images or content) to a physical studio 40, discussed hereinafter. The mixer/selector 28 receives graphics and video from various sources, such as live video, recorded video, video graphics, and other video/images on lines 31,32,33,34, respectively, to be displayed on the virtual screens, and provides one or more selected video/graphics signals (VS1-VSN) on a line 35 to the Video Processing Logic 26, in response to the virtual screen content selection command on the line 29 from the user device 12. The mixer/Selector 28 also provides the one or more selected video/graphics signals (VS1-VSN) on the line 35 to the user device 12, which allows the CC App to display the selected virtual screens (VSs).

The Video Processing Logic 24 may be part of the known video graphics engine 22, e.g., Unreal engine, and performs video processing on the selected video/graphics input signals VS1-VSN on line 35 received from the mixer/selector 28, and provides an RGB video feed signal on a line 23 indicative of the selected video/graphics signals VS1-VSN to be displayed on the virtual screens to the Color Correction Logic 20. The Color Correction Logic 20 receives commands from the CC App 16 based on inputs into the UI from the user to perform color correction on the RGB video feed signal and provides the color corrected RGB video (CC-RGB video) of the selected video signals VS1-VSN on a line 48 to the physical studio to be displayed in the virtual studio environment. The Video Processing Logic 24 also receives test pattern images on a line 39 from a Test Pattern Server 38. The test pattern images are also provided to the user device 18 on the line 39, which allows the CC App 16 to display the selected test pattern images, discussed more hereinafter. The Video Processing Logic 24 communicates with a Virtual Sets Server 42 on a line 43, which provides virtual studio set images for the virtual background studio set (or virtual set image). The Video Processing Logic 24 also receives virtual set select commands on a line 49 from the user device 12 indicative of which virtual studio set to request from the Virtual Sets Server 42, and provides the virtual set image on a line 47 to the physical studio to be displayed in the virtual studio environment. The Video Processing Logic 24 also receives a test pattern select commands on a line 45 from the user device 12 indicative of which virtual test pattern to request from the Test Pattern Server 38, and provides the selected test pattern as the virtual screen image for the selected virtual screen.

The control room 30 communicates with a physical studio 50, having physical walls, floor and ceiling. In particular, to create a virtual studio environment the walls and floor are lined with known LED tiles or panels or displays 52, such as those made by ROE, e.g., Ruby 1.9B V2, having panel dimensions, e.g., 500 mm×500 mm×73 mm (19.7″×19.7″×2.87″) with a predetermined number of LED pixels per panel (or resolution or pitch), e.g., 256×256 LED pixels, which are designed and installed to appear to be seamless single surfaces or LED volume. Other LED tiles, dimensions and resolutions may be used if desired. The video signals from the control room 30 (VS1-VSN CC-RGB Video on the line 48 and Virtual Set Image on the line 47) are provided to an LED driver 53 which provides output signals to the LEDs on lines 57,55 for the virtual screens 58 and virtual set image 56, the resulting combination of virtual images 56, 58 being a virtual studio image 59.

In some embodiments, the virtual screens 58 and virtual set (or background scene) image 51 may be combined into an overall single display image or virtual studio image 59 illuminated by the LED screen in the virtual studio environment. In that case, the video/graphic signals on lines 47 (virtual set background) and 48 (virtual screens) may be combined by the video graphics engine 22 into the single virtual studio image 59 before being sent to the LED driver 53 for display in the virtual studio environment.

The LED tile-covered walls and floors (or LED volume) of these virtual studios may be filmed using a traditional broadcast video camera 54 to give the impression that the live talent personnel 56 in the virtual studio environment are inhabiting a physical environment that has in fact been created all virtually via a virtual set image 51 displayed by illuminating the LED tiles 52 to create a virtual environment or virtual studio image 59. The virtual environment 59 also includes virtual screens or virtual monitors 58 being displayed on the LED tiles, the virtual screens being similar in appearance to physical monitors in traditional studios. The virtual screens 58 are graphics (or videos) displayed on the LED wall tiles 52 that make it appear as if there are separate physical video monitors in the virtual studio environment 59 for the talent 56 to interact with. The virtual screens 58 can display graphics and play video just as if there were additional physical video monitors in the studio.

The studio video out signal from the studio video camera 54, which includes the virtual studio image 59 (including the virtual set 51 and the virtual screens/monitors 58) together with the real talent (i.e., people) 56, is provided on a line 61 to a known video broadcast system 60, which provides the necessary video processing of the studio video output signal and broadcasts the signal by air, shown by a transmitter 62, or by wire/cable, internet (such as video streaming) or other transmission. The studio video out signal from the studio video camera 54 is also provided on the line 61 to the user device 12 to allow the CC App 16 to display the signal being broadcast for review by the user/operator 18 of the system of the present disclosure.

In some embodiments, the Mixer/Selector 28, Video Graphics Engine 22, the Studio 50, and the like, may function and communicate through a standard API (Application Programming Interface), e.g., a REST (REpresentational State Transfer) APIs, as indicated by dashed the boxes labeled Mixer API 64, Graphics Engine API 66, Studio API 68. Also, in some embodiments, a waveform monitor or vectorscope (WM-VS) 54A may be located in the physical studio 50 (or otherwise view the virtual studio) and provide output images or graphs (WM-VS images) on a line 61A to the user device 12 to allow the CC App 16 to display the WM-VS images from the waveform monitor/vectorscope 54A. in that case the WM-VS 54A may function and communicate through the Studio API 68 or other desired interface.

Referring to FIG. 1B, in some embodiments, the physical studio 50 may use projectors instead of LED panels to display the virtual environment or virtual studio image 59. In that case, in some embodiments, there may be a known rear projection system, as shown by known rear projectors 106, or there may be a known front projection system, as shown by known front projectors 104. In that case, the driver 53 that converts the virtual set image and color corrected virtual screen(s) (CC-RGB video) digital video/image signals from the video graphics engine would be a projection (or projector) driver instead of an LED driver to create a virtual studio image 59 for the virtual studio environment. Instead of or in addition to the LED or projection display technology, any other display technology may be used if desired, such as LCD (liquid crystal display), microLED, OLED, AMOLED, Quantum dots (QLED), Flexible displays, Immersive displays, LCD, backlit LCD, TFT LCD, Display technology for business, LCDS, Plasma display, touch screen, or any other display technology now known or later developed, provided it provides the features and performance described herein.

Referring to FIG. 1C, in some embodiments, there may be a plurality of user devices 12 (1-N) each of which can perform color correction when it is in control of color correction for the virtual screens. In that case, the Mixer/Selector 28, Video Graphics Engine 22, CC App Logic 16, Video Processing Logic 24, Color Correction Logic 20, the Studio 50, and the like, may function and communicate through a standard API (Application Programming Interface), e.g., a REST (REpresentational State Transfer) API, as indicated by the boxes labeled Mixer API 64, Graphics Engine API 66, Studio API 68, and collectively may be shown as CC API's 112. Other API types may be used if desired, such as WebSocket or GraphQL APIs. The CC API's may include a data broker which communicates with the user devices connected to the system and manages control so that only one user device is in control of a virtual studio at any time. Having a plurality of user devices capable of controlling a virtual studio may be helpful in the event that the user device in control has technical issues or loses power or has a personnel issue, another user device can take over color correction or other control as needed of the virtual studio.

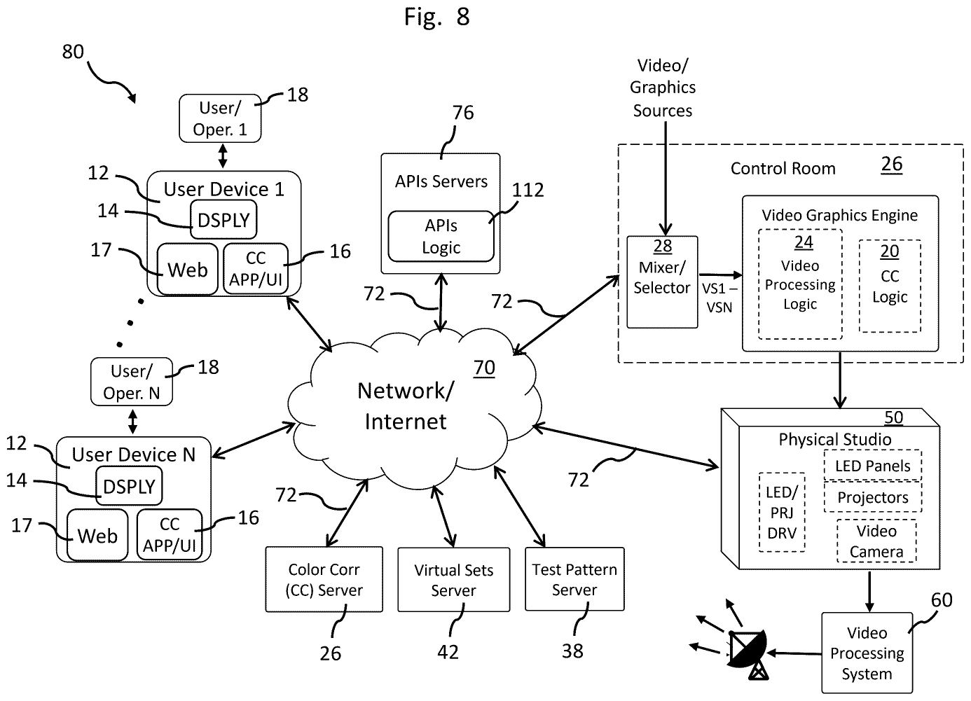

In some embodiments, the user device 12 may also receive API responses comprising content (or data) or instructions (or rules or results or responses) from the various App APIs regarding how to interact with the App APIs (App API call rules), success/failure of the request (e.g., via known codes), and how to access desired content/data (e.g., web address). The software code for the API's (and data broker if used) may be located on a common server, such as the CC Server 26, or may be on separate servers. Also, each of the APIs may have their own URL address. Also, each API may provide multiple services (or respond to multiple requests or queries), such as a configuration service, which provides information or rules for the API calls (or requests or queries) in a configuration (or config or JSON) file, and may also provide other services associated with the API, such as API Request services, e.g., GET, PUT, POST, and DELETE, for a REST API. The system of the present disclosure may also operate in a network configuration as shown in FIG. 8, discussed hereinafter.

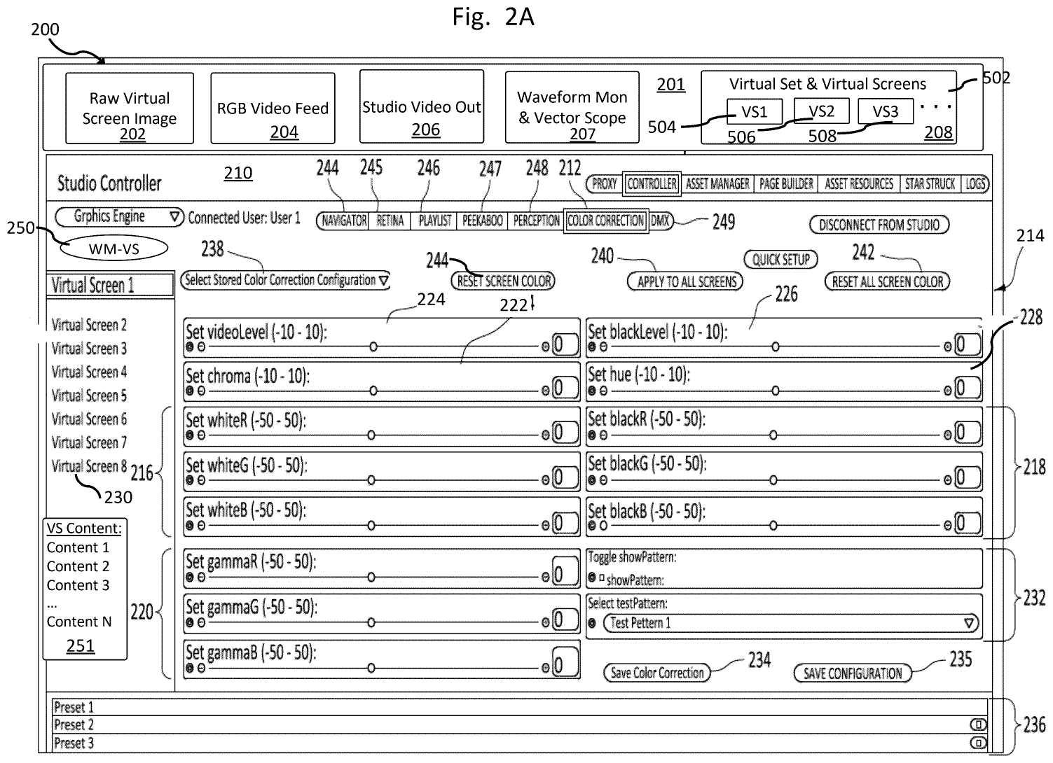

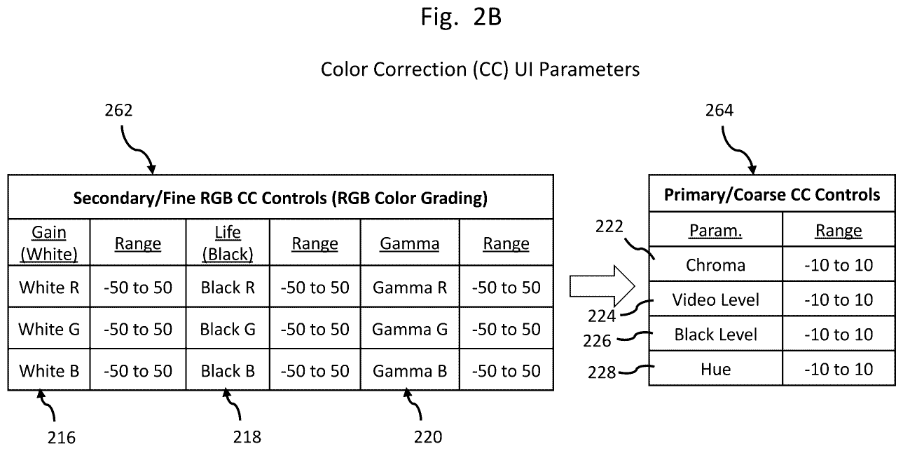

Referring to FIG. 2A, is a screen illustration is shown of a user interface (UI) 200 for a color correction application on a user device of FIG. 1A, in accordance with embodiments of the present disclosure. In particular, the upper portion 201 of the UI screen 200 may have windows or portions 202,204,206 of the UI screen 200 that displays the selected virtual screen (VS1-VSN) image 202, the RGB Video Feed image 204, and the color corrected Studio Video Output image 206 of the selected virtual monitor. In some embodiments, the upper portion 201 may also have a window or portion 207 that displays the output of the waveform monitor/vectorscope 54A. Also, in some embodiments, the upper portion 201 may also have a window or portion 208 that displays the color corrected Studio Video Output signal for the entire studio including the virtual set and all virtual screens (VS1-VSN), showing the location of each of the virtual screens 504,506,508 displayed on the virtual set 502.

The lower portion or studio controller screen 210 of the UI screen 200 is shown with a color correction screen option 212 selected and showing a color correction screen 214 having a plurality of color correction (or adjustment) parameters that the user/operator can adjust within a predetermined adjustment range as shown on the screen 214, e.g., Gain (White) R, Gain (White) G, Gain (White) B, collectively 216, Lift (Black) R, Lift (Black) G, Lift (Black) B, collectively 218, Gamma R, Gamma G, Gamma B, collectively 220, and Chroma 222, VideoLevel 224, BlackLevel 226, and Hue 228.

The left side of the screen 210 shows a virtual screen listing section 230 of the UI screen 214 which lists the various virtual screens content available or connected, e.g., virtual screen 1, virtual screen 2, virtual screen 3, virtual screen 4, virtual screen 5, virtual screen 6, and the like, that may be selected for color correction and viewing by the user. When the user selects (e.g., clicks on) a given virtual screen, shown by the double box, e.g., Virtual Screen 1, the color correction (or adjustment) parameters 216 (White R, G, B), 218 (Black R, G, B), 220 (Gamma R, G. B), 222 (Chroma), 224 (VideoLevel), 226 (BlackLevel), 228 (Hue), on the color correction portion 214 become active for adjusting by the user of the corresponding color correction parameters for selected virtual screen. When a virtual screen is selected, the corresponding virtual screen VS1, VS2, VS3, to VSN in the window 208 will be highlighted or a box illuminated around the corresponding virtual screen. In some embodiments, the user may select the desired screen to color correct by clicking on the corresponding virtual screen 504,506,508 in the window 208.

The left side of the screen 214 also shows a virtual screen (VS) content listing section window 251 which lists the possible content available for display on a given virtual screen/monitor (VS1-VSN), such as live video, recorded video, video graphics, images, other video/images, and the like. When the user selects a given content item (Content 1, Content 2, Content 3, Content N) from the list, the user device 12 sends a signal to the mixer 28 (FIG. 1A) to select the appropriate content on the input lines 31-34, to be displayed on the selected virtual screen (VS1-VSN).

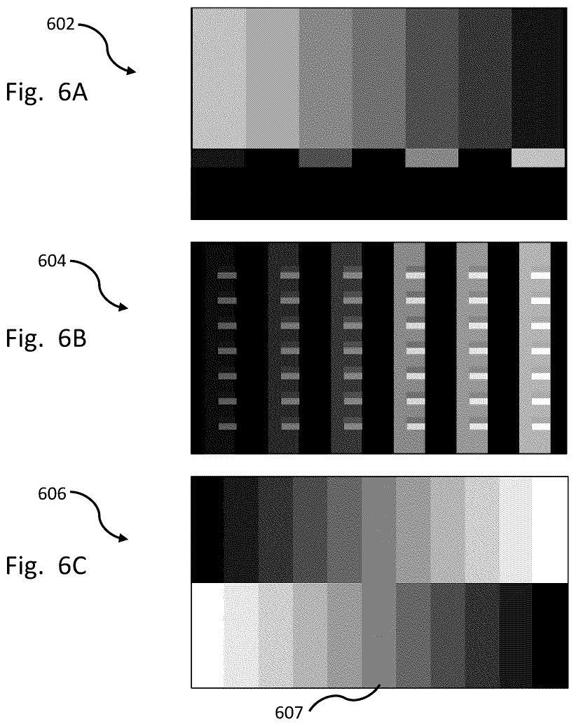

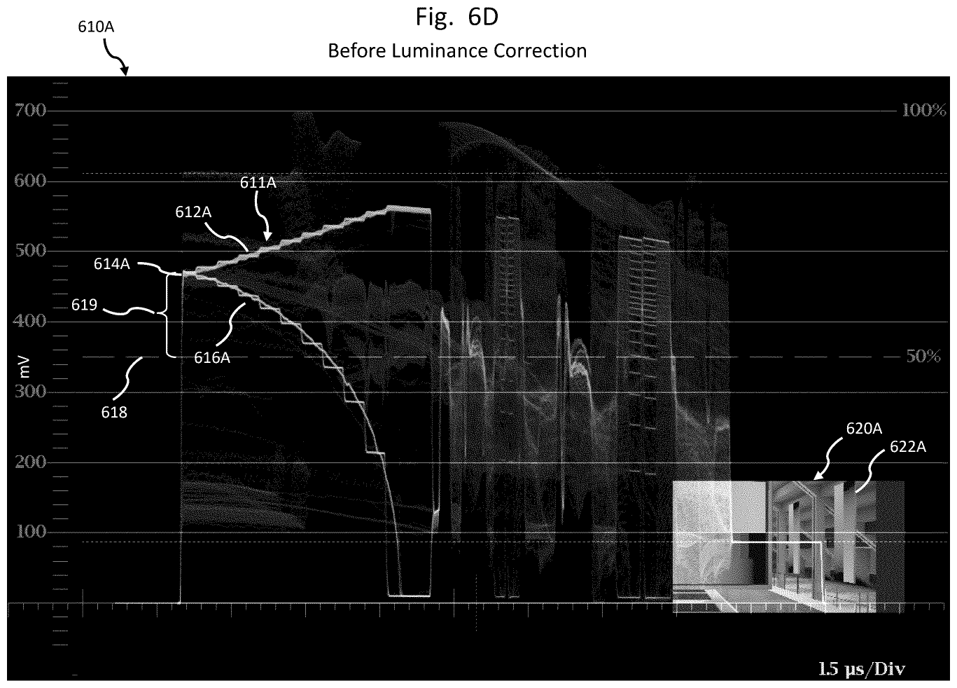

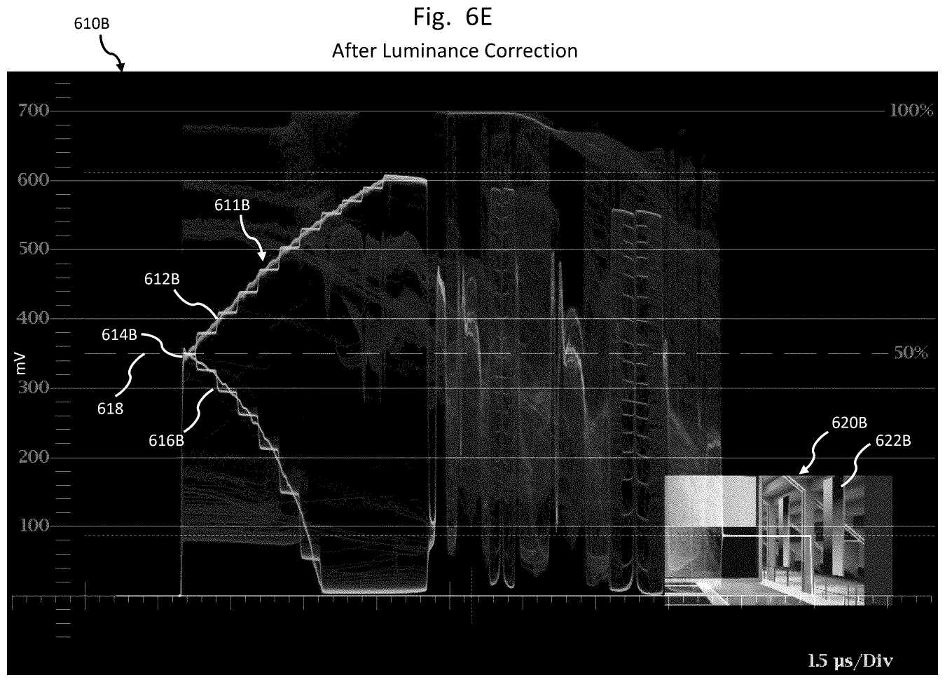

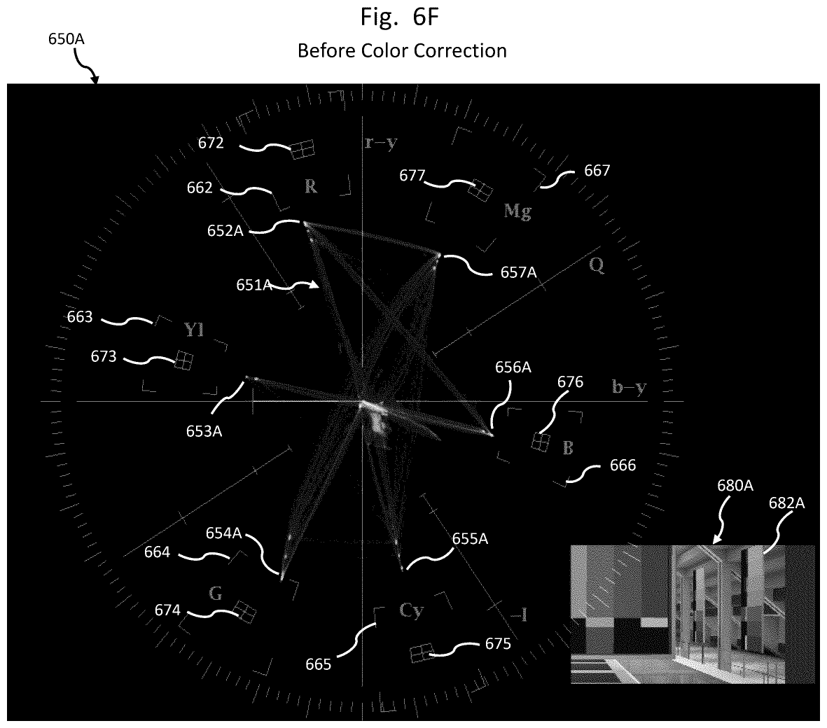

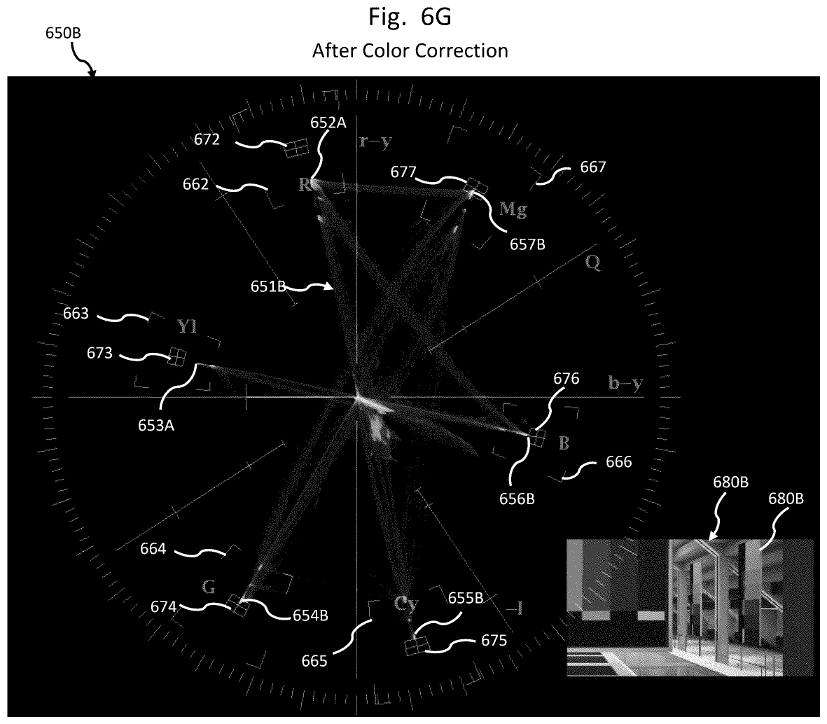

Also, the UI also provides a selectable graphic or button 250 (WM-VS), that when selected, causes the UI to display the waveform monitor/vectorscope images from the WM-VS 54A (FIG. 1A) in the window 207. This allows the user/operator 18 to fine tune the color correction if desired, as discussed hereinafter with FIGS. 6D,6E,6F,6G.

Also, the UI may have a test pattern section 232 that allows the user 18 to insert a test pattern image, e.g., such as the images show in FIGS. 6A, 6B, 6C, and view the results of the selected color correction for a selected virtual monitor on the selected test pattern image. The test pattern section 232 includes a dropdown field labeled “Select test Pattern” to select the desired test pattern and a checkbox in a field labeled “Toggle Show Pattern” to turn on/off the test pattern feature. When the Toggle Show Pattern checkbox in the toggle show pattern field is selected (or checked), the test pattern selected in the select pattern field will be displayed on the selected virtual screen. In that case, the UI raw image window 202, RGB video feed window 204, and Studio video out window 206, each will show the selected test pattern from the corresponding point in the image processing process.

The UI also allows the user 18 to save the color correction by the button 234 and to save the configuration by the button 235. Also, a field 238 allows the user to select a pre-stored color correction configuration via a drop-down listing. The UI also allows user to reset screen color with a reset screen color button 244, to apply the settings to all screens with a button 240, and to reset all screen color with a button 242. The UI also provides a “quick setup” button to allow the user to quickly set up the color correction parameters and a “disconnect from studio” button to allow the user to disconnect the user or the graphics engine from the virtual studio.

Also, the UI allows the user to select the Graphics Engine and shows the connected user. The UI also provides the ability to select presets of the color correction parameters for a given virtual environment or a selected virtual screen, as show in the region 236 at bottom of screen, Preset 1, Preset 2, Preset 3.

Also, the UI and studio controller has other features such as Navigator 244 (moves the view of the virtual “world” seen by the camera to different selectable positions), Retina 245 (virtual camera that tracks the actual camera), Playlist 246 (triggers certain pre-set animations for elements in the virtual scene, e.g., open/close doors), Peekaboo 247 (show/hide certain elements on the virtual scene, e.g., furniture, benches, plants, and the like), Perception 248 (move background to foreground and vice versa), and DMX lighting 249 (control color and brightness of virtual lights as if they were physical lights). For the display shown in FIG. 2A, the Color Correction option 212 was selected as shown by the double box around the 212 option.

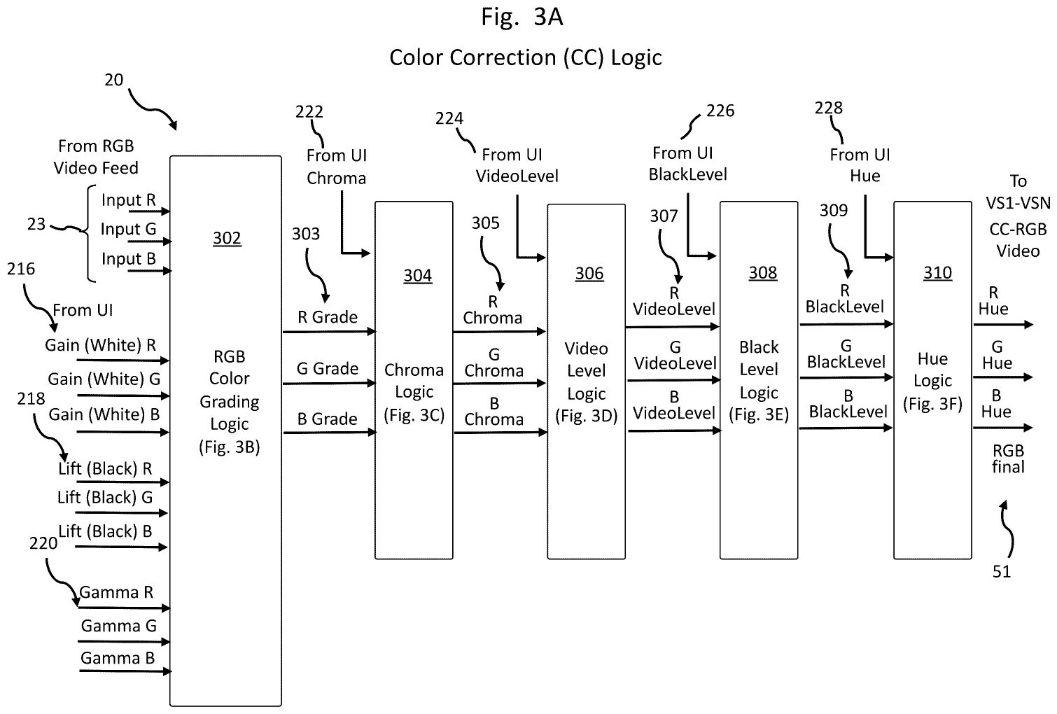

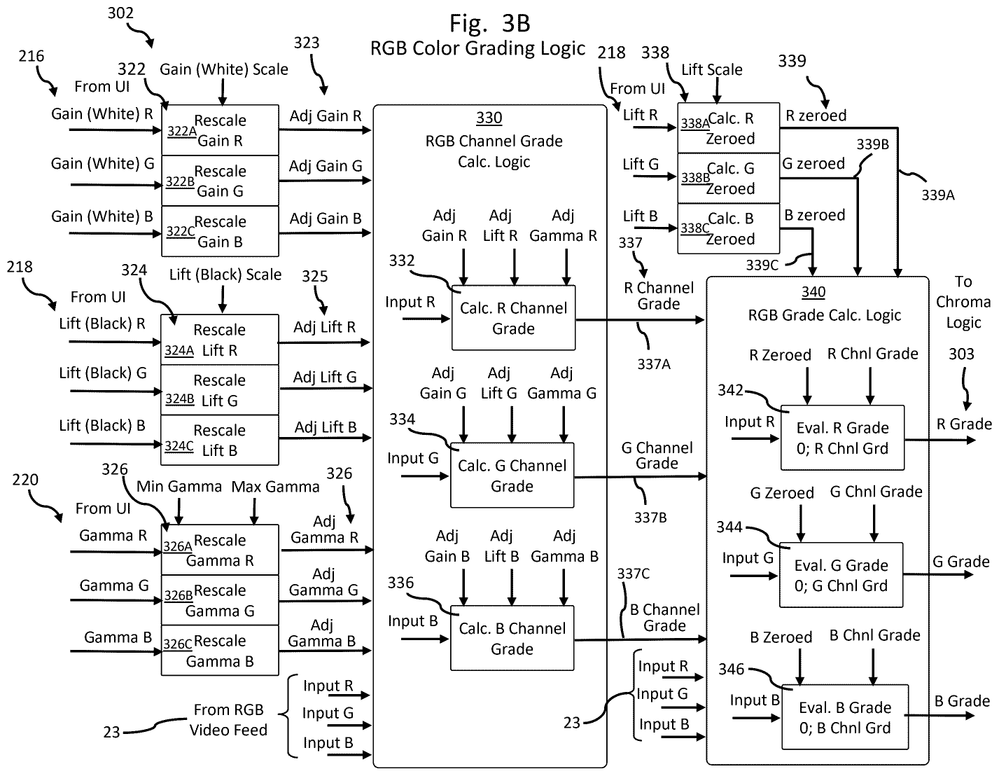

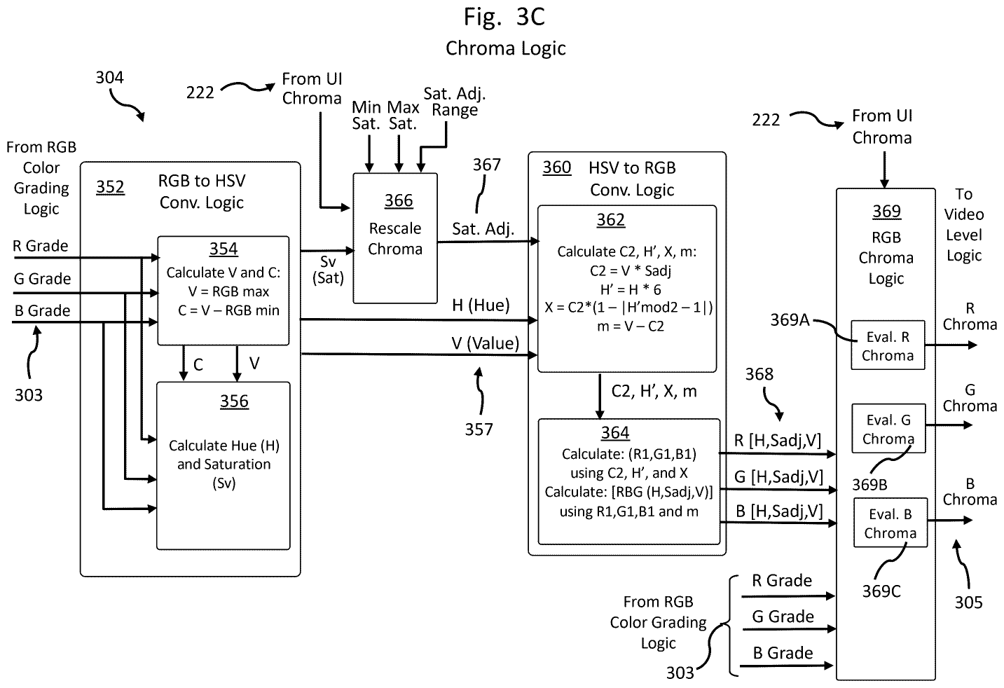

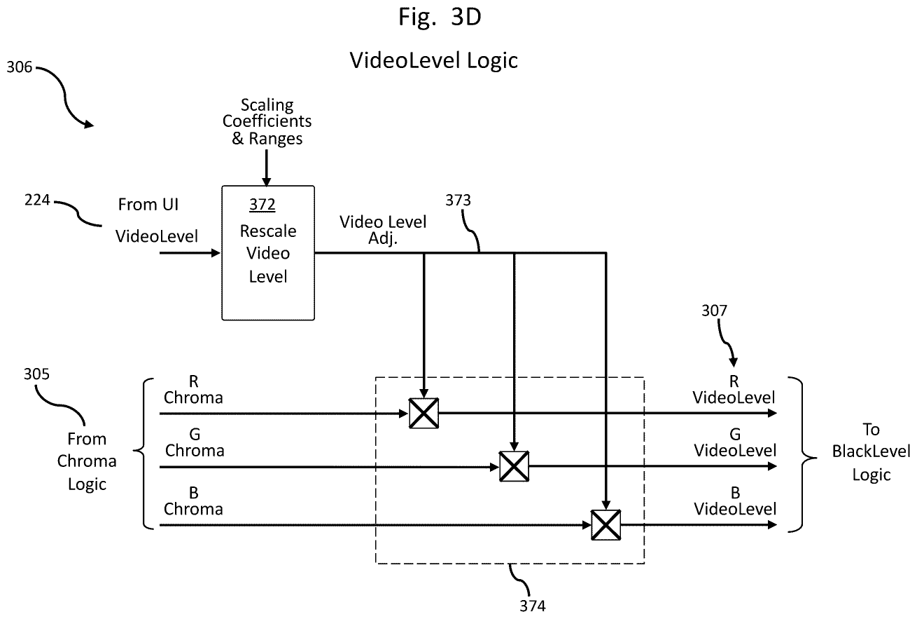

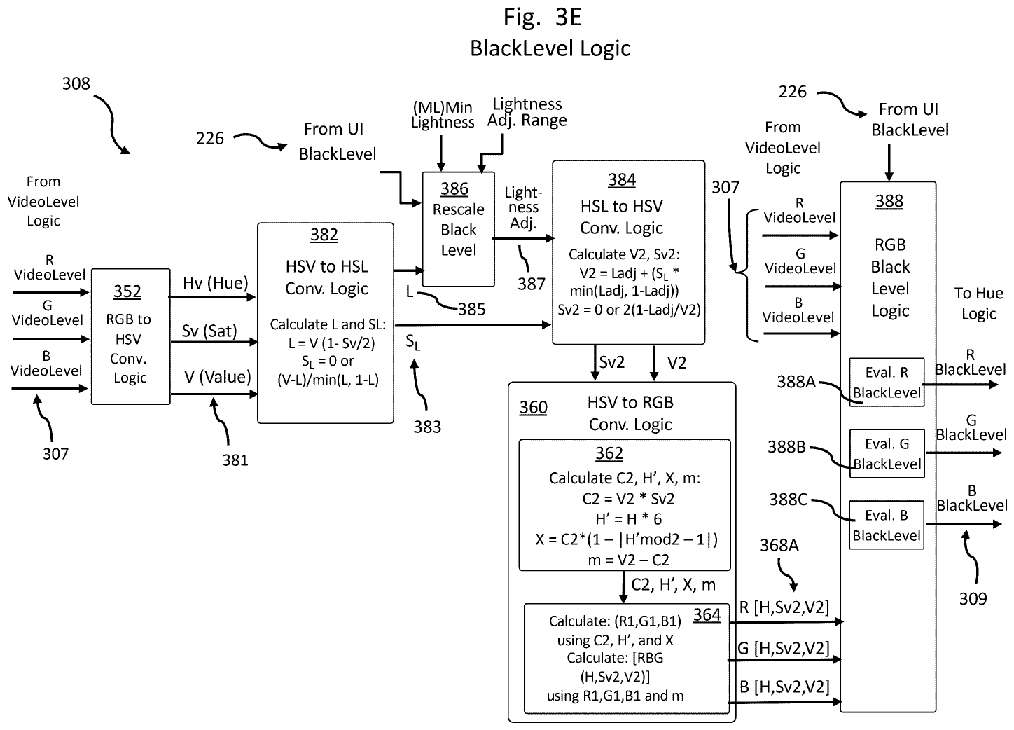

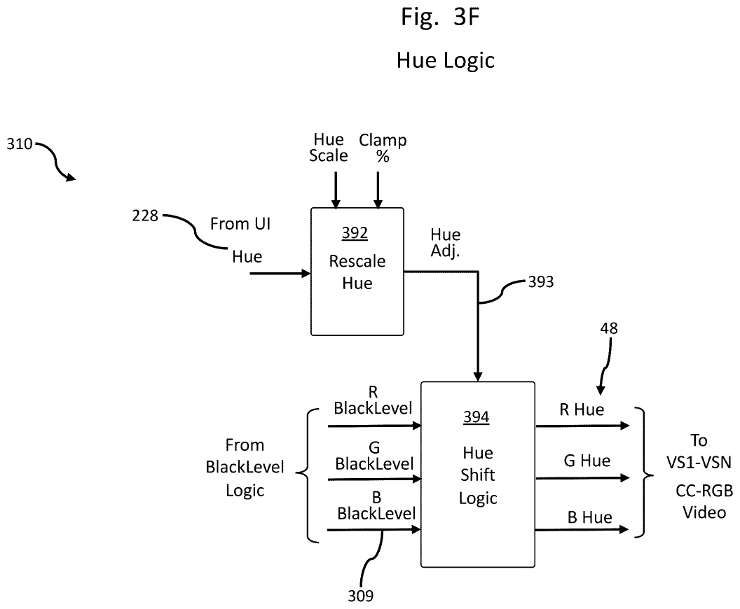

Referring to FIG. 2B, tables 252,254 for color correction UI parameters and ranges as well as a sequence for processing UI input data are shown. In particular, the color correction parameters and ranges may be grouped into two categories: RGB color grading (or fine tuning or secondary) color correction parameters shown in table 252 and coarse (or primary) color correction parameters shown in table 254. RGB color grading parameters table 252 includes Gain (White) R, Gain (White) G, Gain (White) B, shown as a Gain (White) column 216, Lift (Black) R, Lift (Black) G, Lift (Black) B, shown as a Left (Black) column 218, and Gamma R, Gamma G, Gamma B, shown as a Gamma column 220 each having a range of −50 to 50. The coarse (or primary) color correction parameters table 254 includes Chroma 222, VideoLevel 224, BlackLevel 226, and Hue 228, each having a range of −10 to 10. Other ranges may be used if desired. The tables 262, 264 may be stored in the CC Server 26 and the CC App may populate the UI for the color correction parameters based on the ranges in the tables 262, 264. Other ranges may be used if desired, and may be adjusted by the user by modifying the values in the tables 262, 264. FIG. 2B also shows the sequence for processing or converting UI input data to color corrected RGB video by the color correction logic, discussed more hereafter with FIG. 3A.

Referring to FIG. 3A, a top-level data flow diagram for the Color Correction (CC) Logic 20 (FIG. 1A) is shown, which performs color correction on the RBG video feed based on the color correction parameters entered by the user in the UI and provides a color corrected RGB video signal of the virtual screens or monitors which are sent to the studio for display in the virtual environment. To perform color correction of the input RGB video signal, the Color Correction (CC) Logic 20 may be implemented using RGB Color Grading Logic 302, Chroma Logic 304, VideoLevel Logic 306, BlackLevel Logic 308, and Hue Logic 310. In particular, the RGB Color Grading Logic 302 receives the input R, G, B from the RGB video feed 23 (FIG. 1A), and receives Gain (White)R, G, B from the UI section 216, Lift (Black)R, G, B from the UI section 218, and Gamma R, G, B from the UI section 220, and provides R Grade, G Grade, and B Grade, collectively 303 to the Chroma Logic 304. The Chroma Logic 304 receives the R Grade, G Grade, and B Grade, collectively 303, from the RGB Color Grading Logic 302, and provides R Chroma, G Chroma, and B Chroma, collectively 305 to the VideoLevel Logic 306. The VideoLevel Logic 306 receives the R Chroma, G Chroma, and B Chroma, collectively 305 from the Chroma Logic 304 and provides R VideoLevel, G VideoLevel, and B VideoLevel, collectively 307 to the BlackLevel Logic 308. The BlackLevel Logic 308 receives the R VideoLevel, G VideoLevel, and B VideoLevel, collectively 307 from the VideoLevel Logic 306, and provides R BlackLevel, G BlackLevel, and B BlackLevel, collectively 307 to the Hue Logic 310. The Hue Logic 310 receives the R BlackLevel, G BlackLevel, and B BlackLevel, collectively 307 from the BlackLevel Logic 308, and provides R Hue, G Hue, and B Hue, collectively 307 as the final corrected video signal CC-RGB Video for the selected virtual screen image (VS1-VSN).

Referring to FIG. 3B a data flow diagram for RBG Color Grating Logic 302 of FIG. 3A is shown, in accordance with embodiments of the present disclosure. In particular, the RGB Color Grading Logic 302 receives Gain (White) R, G, B from the UI section 216, Lift (Black) R, G, B from the UI section 218, and Gamma R, G, B from the UI section 220, and each of which are rescaled to provide an adjusted parameter. More specifically, the Gain (White) R, G, B from the UI section 216 are individually rescaled via rescale logics 322A,322B,322C using a Gain (White) Scale to provide adjusted Gain R, G, B (Adj Gain R, G, B) collectively 323, which are provided to RGB Channel Grade Calculation Logic 330, discuss more below. Similarly, The Lift (Black) R, G, B from the UI section 218 are individually rescaled via rescale logics 324A,324B,324C using a Lift (Black) Scale to provide adjusted Lift R, G, B (Adj Lift R, G, B) collectively 325 which are provided to RGB Channel Grade Calculation Logic 330, discuss more below. Similarly, The Gamma R, G, B from the UI section 220 are individually rescaled via rescale logics 326A,326B,326C using a Min. Gamma and a Max Gamma to provide adjusted Gamma R, G, B (Adj Gamma R, G, B) collectively 326 which are provided to the RGB Channel Grade Calculation Logic 330, discuss more below. The RGB Channel Grade Calculation Logic 330 also receives the input R, G, B from the RGB video feed on the line(s) 23 (FIG. 1A).

The RGB Channel Grade Calculation Logic 330 calculates intermediate parameters R Channel Grade, G Channel Grade, and B Channel Grade, collectively 337. In particular, R Channel Grade on a line 337A is calculated by taking the RGB video feed Input R, and adjusting it based on Adj Gain R, Adj Lift R, and Adj. Gamma R, shown by box 332. Similarly, G Channel Grade on a line 337B is calculated by taking the RGB video feed Input G, and adjusting it based on Adj Gain G, Adj Lift G, and Adj. Gamma G shown by box 334. Similarly, B Channel Grade on a line 337C is calculated by taking the RGB video feed Input B, and adjusting it based on Adj Gain B, Adj Lift B, and Adj. Gamma B shown by box 336.

The R Channel Grade, G Channel Grade, and B Channel Grade, collectively 337, are fed to an RGB Grade Calculation Logic 340, which also receives the input R, G, B from the input RGB video feed on the lines 23 (FIG. 1A), as well as inputs RGB zeroed values, collectively 339 (discussed hereinafter). The RGB Grade Calculation Logic 340 calculates parameters R Grade, G Grade, and B Grade, collectively 303, which are the color graded RGB values, adjusted by the Gain (White) RGB, Lift (Black) RGB and Gamma RGB user inputs 216,218,220 from the UI. In particular, R Grade is determined by taking the RGB video feed Input R, and determining a value for R Grade based on the R Zeroed value and the R Channel Grade value shown by box 342. Similarly, G Grade is determined by taking the RGB video feed Input G, and determining a value for G Grade based on the G Zeroed value and the G Channel Grade value, shown by box 344. Similarly, B Grade is determined by taking the RGB video feed Input B, and determining a value for B Grade based on the B Zeroed value and the B Channel Grade value, shown by box 346.

Also, the R Zeroed, G Zeroed, B Zeroed, collectively 339, are individually determined by using Lift R, Lift G, Lift B, collectively 218 from the UI, and a Lift (Black) Scale to provide R Zeroed, G Zeroed, B Zeroed collectively 239 on lines 339A, 339B, 339C, respectively, which are provided to RGB Grade Calculation Logic 340 for determining R Grade, G Grade, B Grade.

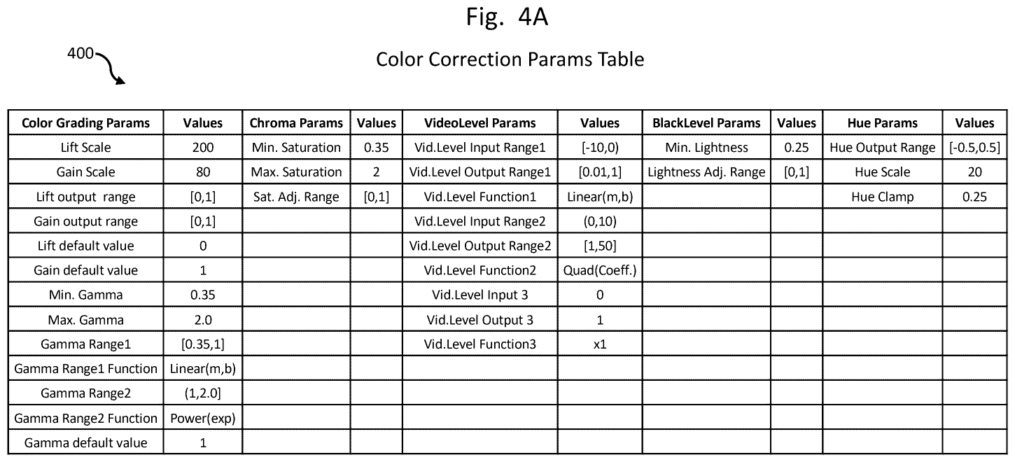

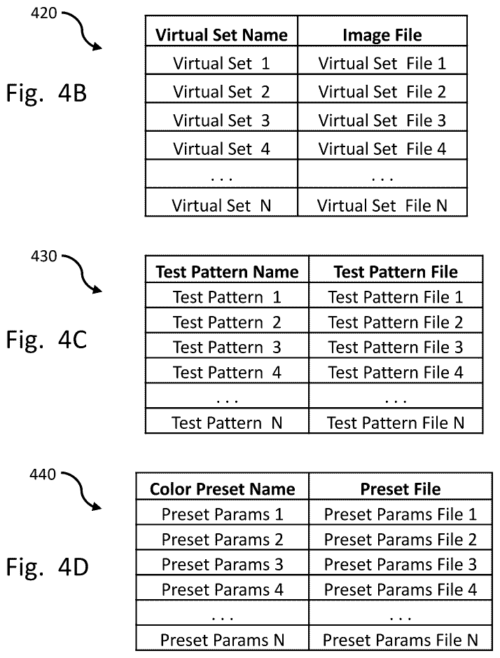

The scale factors Gain (White) Scale, Lift (Black) Scale, and Min Gamma, and Max Gamma, may be retrieved from the CC Server, and may be stored in a Color Correction Parameters Table 400 shown in FIG. 4A, or stored in and retrieved from the graphics or game engine 22, discussed more hereinafter.

Referring to FIG. 3C a data flow diagram for Chroma Logic 304 of FIG. 3A is shown, in accordance with embodiments of the present disclosure. In particular, the Chroma Logic 352 receives the inputs R, G, B from the RGB video feed on the line(s) 23 (FIG. 1A), which are provided to an RGB to HSV Conversion Logic 352, which converts the RGB video feed signal to HSV (Hue, Value, Saturation) values. The RGB to HSV Conversion Logic 352 uses the inputs R Grade, G Grade, B Grade from the RGB Color Grading Logic 302 to calculate values for V (Value), C, and Sv (Sat).

The Sat. Adj. value on line 367 is determined by Rescale Chroma Logic 366, using the Chroma 222 from the UI, the Saturation value (Sv) from the RGB to HSV Conversion Logic 352, and a Max Saturation, Min. Saturation, and Saturation Adjust Range, to rescale the Chroma UI input to an appropriate range (Sat. Adj. value) for use by RGB Chroma Logic 369 to adjust the saturation value (Sv) or level. The values for H (Hue), Sadj (Saturation adjust), and V (Value) are provided to an HSV to RGB Conversion Logic 360, which converts H (Hue), Sadj (Saturation adjust), and V (Value) to RGB [H, S, V] to allow the saturation (Sadj) component of RGB to be adjusted.

The Logic 360 provides the RGB [H, Sadj, V] on lines 368, to RGB Chroma Logic, which also receives R Grade, G Grade, B Grade on lines 303, the Chroma 222 from the UI, and a Saturation Adjust (Sat. Adj.) on line 367 to calculate R Chroma, G Chroma, B Chroma, the chroma adjusted RGB (or the saturation component of RGB adjusted by the Chroma input from the UI). The R Chroma, G Chroma, B Chroma are provided on lines 305 to the VideoLevel Logic, discussed below.

More specifically, the RGB Chroma Logic 369 calculates R Chroma, G Chroma, B Chroma using Evaluate R Chroma Logic 369A, Evaluate G Chroma Logic 369B, Evaluate B Chroma Logic 369C, respectively. In particular, the Evaluate R Chroma Logic 369A, determines if the Chroma 222 value from the UI is equal to zero (0). If yes, the value of R Chroma is set to the value of R Grade. If Chroma 222 value from the UI is not equal to zero (0), R Chroma value is set to the value of R [H, Sadj, V], where Sat. Adj is the adjusted value for S (saturation) from logic 366. Similarly, the Evaluate G Chroma Logic 369B, determines if the Chroma 222 value from the UI is equal to zero (0). If yes, the value of G Chroma is set to the value of G Grade. If the value of Chroma 222 from the UI is not equal to zero (0), the G Chroma value is set to the value of G [H, Sadj, V], where Sat. Adj is the adjusted value for S (saturation) from logic 366. Similarly, the Evaluate B Chroma Logic 369C, determines if the Chroma 222 value from the UI is equal to zero (0). If yes, the value of B Chroma is set to the value of B Grade. If the value of Chroma 222 from the UI is not equal to zero (0), the B Chroma value is set to the value of B [H, Sadj, V], where Sat. Adj is the adjusted value for S (saturation) from logic 366.

The scale factors and ranges such as Min. Sat. Max. Sat., Sat. Adj. Range, and the like, may be retrieved from the CC Server 26, and may be stored in the Color Correction Parameters Table 400 shown in FIG. 4A or stored in and retrieved from the graphics or game engine 22, discussed more hereinafter.

Referring to FIG. 3D a data flow diagram for the VideoLevel Logic 306 of FIG. 3A is shown, in accordance with embodiments of the present disclosure. In particular, the VideoLevel Logic 306 receives the R Chroma, G Chroma, B Chroma values on the lines 305 and the VideoLevel input 224 from the UI. The VideoLevel input 224 from the UI is rescaled via rescale logic 372 using a scaling coefficients and ranges, e.g., having values as shown in the table 400 of FIG. 4A, which may be stored on the CC server or within the graphics engine, to provide a VideoLevel Adjust value on a line 373. The VideoLevel Adj. is multiplied by R Chroma, G Chroma, B Chroma values to provide R VideoLevel, G VideoLevel and B VideoLevel on lines 307, which is provided to the BlackLevel Logic 308, discussed below.

Referring to FIG. 3E a data flow diagram for BlackLevel Logic 308 of FIG. 3A is shown, in accordance with embodiments of the present disclosure. In particular, the BlackLevel Logic 308 receives the R VideoLevel, G VideoLevel and B VideoLevel on lines 307 from the VideoLevel Logic which are provided to the RGB to HSV conversion logic 352 (same as used in the Chroma Logic), which provides values for H (Hue), S (Sat), and V (Value) on lines 381 which are provided to an HSV to HSL Conversion Logic 382, which converts the HSV (Hue, Sat, Value) values to HSL (Hue, Sat., Lightness) values. The HSV to HSL Conversion Logic 382 uses the HSV values to calculate values for L and Sv. The value for L (Lightness) is provided on a line 385 to Rescale BlackLevel logic 386, which uses the L (Lightness) and the BlackLevel 226 from the UI as well as Min. Lightness and Lightness Adjust Range, e.g., having values as shown in the table 400 of FIG. 4A, which may be stored on the CC server or within the graphics engine, to rescale the BlackLevel input 226 from the UI to provide a Lightness Adjust (Ladj) parameter on a line 387 for adjusting the Lightness at an appropriate level.

The values for Ladj and Sv are provided on lines 387, 383 to HSL to HSV Conversion Logic 384, which determines the values for intermediate parameters Sv2 and V2, which are provided to HSV to RGB Conversion Logic 360, 362, 364, which is the same HSV to RGB conversion logic used in the Chroma Logic 304, except using Sv2 and V2 (instead of Sadj and V), which provides RGB [H, Sv2, V2] on lines 368A to RGB Black Level Logic 388. The RGB BlackLevel Logic 388 also receives R VideoLevel, G VideoLevel and B VideoLevel on the lines 307 from the VideoLevel Logic 306.

More specifically, the RGB BlackLevel Logic 388 calculates R BlackLevel, G BlackLevel, and R BlackLevel using Evaluate R BlackLevel Logic 388A, Evaluate G BlackLevel Logic 388B, Evaluate B BlackLevel Logic 388C, respectively. In particular, the Evaluate R Chroma Logic 388A, determines if the UI BlackLevel 226 value from the UI is equal to zero (0). If yes, the value of R BlackLevel is set to the value of R VideoLevel. If BlackLevel 226 value from the UI is not equal to zero (0), R BlackLevel value is set to the value of R [H, Sv2, V2], where Sv2 and V2 are from the HSL to HSV conversion logic 384 which uses the adjusted value for Lightness (Ladj) from logic 386. Similarly, the Evaluate G BlackLevel Logic 388B and the Evaluate B BlackLevel Logic 388C use the value of UI BlackLevel 226, to provide values for G BlackLevel, and B BlackLevel. The output values for R BlackLevel, G BlackLevel, and B BlackLevel are provided on lines 309 to the Hue Logic 310.

Referring to FIG. 3F a data flow diagram for the Hue Logic 310 of FIG. 3A is shown, in accordance with embodiments of the present disclosure. In particular, the Hue Logic 310 receives the R BlackLevel, G BlackLevel, and R BlackLevel values on the lines 309 and the Hue input 228 from the UI. The Hue input 228 from the UI is rescaled via rescale logic 392 using a scaling coefficients and ranges, such a Hue Scale and Clamp %, e.g., having values as shown in the table 400 of FIG. 4A, which may be stored on the CC server or within the graphics engine, to provide a Hue Adjust (Hue Adj.) value on a line 373. The Hue Adj. is provided on a line 393 to Hue Shift Logic 394, which also receives the R BlackLevel, G BlackLevel, and R BlackLevel values and provides an adjusted Hue for the RGB signal as the final color corrected output of CC-RGB video on lines 48 (FIG. 1A).

In some embodiments, the scale factors, min/max values, clamp values, and the like for the above logic described above with FIGS. 3A-3F may be stored/retrieved internally within the graphics or game engine 22, or within the plug-in CC Logic 20. In that case, such parameter values would be exposed and accessible within the graphic engine, e.g., the Unreal Materials Editor, so they can be set by an administrator or system operator or user.

The logic described above with FIGS. 3A-3F, may be performed using the below Equations 1 to 5 (Eq. 1-Eq. 5).

For every pixel of an input image where the vector [R, G, B] is represented with shorthand RGB, and for scalar input parameters: LiftR, LiftG, LiftB, GammaR, GammaG, GammaB, GainR, GainG, and GainB be in [−50, 50] with default 0, and Chroma, BlackLevel, VideoLevel, and Hue in [−10, 10] with default 0.

To color correct [R, G, B] to [R_{Final}, G_{Final}, B_{Final}] with the Color Correction Logic 20, which may be also referred to herein as GRACE (Graphic Realtime Auto Color Engine) Color Correction Plugin, the following five equations, Equation 1, Equation 2, Equation 3, Equation 4, Equation 5 (or Eq. 1-Eq. 5) are applied in order, which correspond to the five logics described hereinabove: RGB Color Grading Logic 302, Chroma Logic 304, VideoLevel Logic 306, BlackLevel Logic 308, and Hue Logic 310. The equations are combinations of known formulas, generated equations, and introduced mathematical adjustments to target a practical range of applied color corrections (vs. the entire mathematically possible range of color corrections).

Equation 1: Color Grading [R, G, B] to [R_{Grade}, G_{Grade}, B_{Grade}], described above as the RGB Color Grading Logic 302 (FIG. 3B).

The color grading adjustments impact the black levels, white levels, and curve between those points each individual color channel R, G, and B in an input texture, vector [R, G, B], represented by RGB. These adjustments add and remove R, G, and B from the shadows, midtones, and highlights based on the lift/black, gamma, and gain/white inputs.

Input parameters BlackR, BlackG, BlackB, GammaR, GammaG, GammaB, WhiteR, WhiteG, and WhiteB are in [−50, 50]. They are scaled to target a practical range of values for color correction. LiftR, LiftG, and LiftB are scaled by one factor and GainR, GainG, and GainB are scaled by another. All Lift and Gain values are scaled in [0, 1] where the Gain default values are 1 and the Lift defaults values are 0. GammaR, GammaG, and GammaB are scaled in [0.35, 2.0] with default values of 1. Gamma values in [0.35, 1] yield a graphed linear equation, and gamma values (1, 2] yield a power function.

$$let MinimumGamma = 0.35$$

$$let MaximumGamma = 2.$$

$$let LiftScale = 200.$$

$$let GainScale = 80.$$

$$let AdjustGainR = \frac{GainR + GainScale}{GainScale} , clamp ∈ [ - 50 , 50 ]$$

$$let AdjustGainG = \frac{GainB + GainScale}{GainScale} , clamp ∈ [ - 50 , 50 ]$$

$$let AdjustGainB = \frac{GainB + GainScale}{GainScale} , clamp ∈ [ - 50 , 50 ]$$

$$let AdjustLiftR = \frac{LiftR}{LiftScale} , clamp ∈ [ - 50 , 50 ]$$

$$let AdjustLiftG = \frac{LiftG}{LiftScale} , clamp ∈ [ - 50 , 50 ]$$

$$let AdjustLiftB = \frac{LiftB}{LiftScale} , clamp ∈ [ - 50 , 50 ]$$

$$let AdjustGammaR = \{ \begin{matrix}1 + ( \frac{GammaR}{50} * ( \frac{MaximumGamma - 1}{10} ) ) , & GammaR > 0 \\ 1 , & GammaR = 0 \\ 1 - ( \frac{1 - MinimumGamma}{10} * \frac{GammaR}{50} ) , & GammaR < 0\end{matrix}$$

$$let AdjustGammaG = \{ \begin{matrix}1 + ( \frac{GammaG}{50} * ( \frac{MaximumGamma - 1}{10} ) ) , & GammaG > 0 \\ 1 , & GammaG = 0 \\ 1 - ( \frac{1 - MinimumGamma}{10} * \frac{GammaG}{50} ) , & GammaG < 0\end{matrix}$$

$$let AdjustGammaB = \{ \begin{matrix}1 + ( \frac{GammaB}{50} * ( \frac{MaximumGamma - 1}{10} ) ) , & GammaB > 0 \\ 1 , & GammaB = 0 \\ 1 - ( \frac{1 - MinimumGamma}{10} * \frac{GammaB}{50} ) , & GammaB < 0\end{matrix}$$

$$let AdjustGammaR , AdjustGammaG , AdustGammaB clamp ∈ [ - 50 , 50 ]$$

$$let function ChannelGrade ( ColorChannel , Gain , Gamma , Lift ) = {( Gain * ( ColorChannel + Lift * ( 1 - ColorChannel ) ) )}^{\frac{1}{Gamma}}$$

Apply function ChannelGrade to each color channel R, G, and B in input texture [R, G, B], yielding R_{ChannelGrade}, G_{ChannelGrade}, B_{ChannelGrade}.

$$ChannelGrade ( R , AdjustGainR , AdjustGammaR , AdjustLiftR ) = {( AdjustGainR * ( R + AdjustLiftR * ( 1 - R ) ) )}^{\frac{1}{AdjustGammaR}}$$

$$ChannelGrade ( R , AdjustGainR , AdjustGammaR , AdjustLiftR ) = {R}_{ChannelGrade}$$

$$ChannelGrade ( G , AdjustGainG , AdjustGammaG , AdjustLiftG ) = {( AdjustGainG * ( G + AdjustLiftG * ( 1 - G ) ) )}^{\frac{1}{AdjustGammaG}}$$

$$ChannelGrade ( G , AdjustGainG , AdjustGammaG , AdjustLiftG ) = {G}_{ChannelGrade}$$

$$ChannelGrade ( B , AdjustGainB , AdjustGammaB , AdjustLiftB ) = {( AdjustGainB * ( B + AdjustLiftB * ( 1 - B ) ) )}^{\frac{1}{AdjustGammaB}}$$

$$ChannelGrade ( B , AdjustGainB , AdjustGammaB , AdjustLiftB ) = {B}_{ChannelGrade}$$

$$Calculate the values {R}_{Zeroed} , {G}_{Zeroed} , {B}_{Zeroed} where$$

R_{ChannelGrade}, G_{ChannelGrade}, B_{ChannelGrade} evaluate to 0, then return either R_{ChannelGrade}, G_{ChannelGrade}, B_{ChannelGrade} (if the input value is greater than the zeroed value) or 0 (if the input value is less than the zeroed value) per color channel.

$$let {R}_{Zeroed} = \frac{1}{1 - ( \frac{LiftScale}{LiftR} )}$$

$$let {R}_{Grade} = \{ \begin{matrix}0 , & R > {R}_{Zeroed} \\ {R}_{ChannelGrade} , & R \leq {R}_{Zeroed}\end{matrix}$$

$$let {G}_{Zeroed} = \frac{1}{1 - ( \frac{LiftScale}{LiftG} )}$$

$$let {G}_{Grade} = \{ \begin{matrix}0 , & G > {G}_{Zeroed} \\ {G}_{ChannelGrade} , & G \leq {G}_{Zeroed}\end{matrix}$$

$$let {B}_{Zeroed} = \frac{1}{1 - ( \frac{LiftScale}{LiftB} )}$$

$$let {B}_{Grade} = \{ \begin{matrix}0 , & B > {B}_{Zeroed} \\ {B}_{ChannelGrade} , & B \leq {B}_{Zeroed}\end{matrix}$$

Combine the results into a color graded vector [R_{Grade}, G_{Grade}, B_{Grade}].

$$ColorGrading ( [ R , G , B ] , GainR , GainG , GainB , GammaR , GammaG , \\ GammaB , LiftR , LiftG , LiftB ) = [ {R}_{Grade} , {G}_{Grade} , {B}_{Grade} ] = {RGB}_{Grade}$$

Equation 2: Chroma [R_{Grade}, G Grade, B Grade] to [R_{Chroma}, G_{Chroma}, B_{Chroma}], described above as Chroma Logic 304 (FIG. 3C).

The Chroma adjustment impacts the saturation of an input texture, vector [R_{Grade}, G_{Grade}, B_{Grade}], represented by RGB Grade.

Input parameter Chroma is in [−10, 10]. Saturation is adjusted by converting from color space RGB (Red, Green, Blue) to HSV (Hue, Saturation, Value) and directly modifying the saturation (S, in HSV) level of the texture. We do so by scaling the input parameter in [0, 1], identifying the initial saturation level, and introducing maximum and minimum allowed saturations for practical adjustments only. To convert from RGB to HSV:

For input texture, vector [R, G, B], with R, G, B∈[0,1]

$$let {X}_{Max} = max ( R , G , B ) = V , where V is Value$$

$$let {X}_{Min} = min ( R , G , B ) = V - C , where C is Chroma$$

$$let C = {X}_{Max} - {X}_{Min}$$

$$let H = Hue = \{ \begin{matrix}0 , & C = 0 \\ \frac{( \frac{G - B}{C} mod 6 )}{6} , & V = R \\ \frac{( \frac{B - R}{C} + 2 )}{6} , & V = G \\ \frac{( \frac{R - G}{C} + 4 )}{6} , & V = B\end{matrix}$$

$$let S = Saturation = \{ \begin{matrix}0 , & V = 0 \\ \frac{C}{V} , & V \neq 0\end{matrix}$$

let function RGBtoHSV([R, G, B])=[H, S, V], with H, S, V∈[0, 1] To convert from HSV to RGB:

For input texture, vector [H, S, V], with H, S, V∈[0, 1]

$$let C = V * S , where C is Chroma$$

$$let {H}^{′} = H * 6$$

$$let X = C * ( 1 - \vert {H}^{′} mod 2 - 1 \vert )$$

$$let [ {R}_{1} , {G}_{1} , {B}_{1} ] = \{ \begin{matrix}[ C , X , 0 ] , & 0 \leq {H}^{′} < 1 \\ [ X , C , 0 ] , & 1 \leq {H}^{′} < 2 \\ [ 0 , C , X ] , & 2 \leq {H}^{′} < 3 \\ [ 0 , X , C ] , & 3 \leq {H}^{′} < 4 \\ [ X , 0 , C ] , & 4 \leq {H}^{′} < 5 \\ [ C , 0 , X ] , & 5 \leq {H}^{′} \leq 6\end{matrix}$$

$$let m = V - C$$

$$let [ R , G , B ] = [ {R}_{1} + m , {G}_{1} + m , {B}_{1} + m ]$$

$$let function HSVtoRGB ( [ H , S , V ] ) = [ R , G , B ] , with R , G , B ∈ [ 0 , 1 ]$$

$$let Max Saturation = 0.7$$

$$let Min Saturation = 0.22$$

$$let HSV = [ H , S , V ] = RGBtoHSV ( {R}_{Grade} )$$

$$let SaturationAdjust = \{ \begin{matrix}S + ( \frac{\begin{matrix}S - ( Max Saturation + \\ S , clamp ∈ [ 0 , 1 ] )\end{matrix}}{10} * Chroma ) , & Chroma > 0 and S \geq \\ & Min Saturation \\ S , & Chroma > 0 and S < \\ & Min Saturation \\ S + ( \frac{S}{10} * Chroma ) , & Chroma < 0\end{matrix}$$

let SaturationAdjust clamp∈[0, 1]

$$Chroma ( {RGB}_{Grade} , Chroma ) = \{ \begin{matrix}{RGB}_{Grade} , & Chroma = 0 \\ HSVtoRGB ( [ H , SaturationAdjust , V ] ) , & Chroma \neq 0\end{matrix}$$

$$Chroma ( {RGB}_{Grade} , Chroma ) = [ {R}_{Chroma} , {G}_{Chroma} , {B}_{Chroma} ] = {RGB}_{Chroma}$$

Equation 3: Video Level [R_{Chroma}, G_{Chroma}, B_{Chroma}] to [R_{VideoLevel}, G_{VideoLevel}, B_{VideoLevel}], also described as VideoLevel Logic 306 (FIG. 3D).

The Video Level adjustment is a multiplier that either boosts or decreases the overall brightness of an input texture, vector [R_{Chroma}, G_{Chroma}, B_{Chroma}], which is represented by RGB chroma

Input parameter VideoLevel is in [−10, 10]. For input [−10, 0), we linearly scale to adjusted range [0.01, 1]. For input (0, 10], we exponentially scale to adjusted range [1, 50]. For input 0, we apply a multiplier of 1 (meaning no change is applied).

$$let VideoLevelAdjust = \{ \begin{matrix}( \frac{53 * {VideoLevel}^{2}}{120} + \frac{29 * VideoLevel}{60} + 1 ) , & VideoLevel > 0 \\ ( \frac{0.99 * VideoLevel}{10} ) + 1 , & VideoLevel < 0 \\ 1 , & VideoLevel = 0\end{matrix}$$

$$VideoLevel ( {RGB}_{Chroma} , VideoLevelAdjust ) = {RGB}_{Chroma} * VideoLevelAdjust$$

$$VideoLevel ( {RGB}_{Chroma} , VideoLevelAdjustevel ) = [ {R}_{VideoLevel} , {G}_{VideoLevel} , {B}_{VideoLevel} ] = {RGB}_{VideoLevel}$$

Equation 4: Black Level [R_{VideoLevel}, G_{VideoLevel}, B_{VideoLevel}] to [R_{BlackLevel}, G_{BlackLevel}, B_{BlackLevel}], also described as BlackLevel Logic 308 (FIG. 3E).

The Black Level adjustment impacts the lightness of an input texture, vector [R_{VideoLevel}, G_{VideoLevel}, B_{VideoLevel}], represented by RGB_{VideoLevel}.

Input parameter BlackLevel is in [−10, 10]. Black Level is adjusted by converting from color space RGB (Red, Green, Blue) to HSV (Hue, Saturation, Value), converting from HSV to HSL (Hue, Saturation, Lightness), and directly modifying the lightness (L, in HSL) level of the texture. We do so by scaling the input parameter in [0, 1], identifying the initial lightness level, and introducing a minimum allowed lightness for practical adjustments only.

See Equation 2 (Chroma Logic 304) for conversion logic functions RGB to HSV and HSV to RGB.

To Convert from HSV to HSL (HSV to HSL Conversion Logic 382 FIG. 3E):

For input texture, vector [H_{V}, S_{V}, V], with H_{V}, S_{V}, V∈[0, 1]

let H_{L}=H_{V}, where Huis Hue

$$let L = V * ( 1 - \frac{{S}_{V}}{2} ) , where L is Lightness$$

$$let {S}_{L} = \{ \begin{matrix}0 , & L = 0 or L = 1 \\ \frac{V - L}{min ( L , 1 - L )} & L \neq 0 and L \neq 1\end{matrix}$$

let function HSVtoHSL([H_{V}, S_{V}, V])=[H_{L}, S_{L}, L], with H_{L}, S_{L}, L∈[0, 1]

To Convert from HSL to HSV (HSL to HSV Conversion Logic 384 FIG. 3E):

For input texture, vector [H_{L}, S_{L}, L], with H_{L}, S_{L}, L∈[0, 1]

let H_{V}=H_{L}, where H_{L} is Hue

$$let V = L + ( {S}_{L} * min ( L , 1 - L ) ) , where V is Value$$

$$let {S}_{V} = \{ \begin{matrix}0 , & V = 0 \\ 2 * ( 1 - \frac{L}{V} ) , & V \neq 0\end{matrix}$$

let function HSVtoHSL([H_{V}, S_{V}, V])=[H_{L}, S_{L}, L], with H_{L}, S_{L}, L∈[0, 1]

$$let Min Lightness = ML = 0.25$$

$$let {HSV}_{VideoLevel} = [ {H}_{VideoLevel} , {S}_{VideoLevel} , {V}_{VideoLevel} ] = RGBtoHSV ( {RGB}_{VideoLevel} )$$

$$let {HSL}_{Adjust} = [ {H}_{Adjust} , {S}_{Adjust} , {L}_{Adjust} ] = HSVtoHSL ( {HSV}_{VideoLevel} )$$

$$let LightnessAdjust = \{ \begin{matrix}BlackLevel + ( \frac{( 1 - L , clamp ∈ [ 0 , ML ] )}{50} * BlackLevel ) , & - 5 \leq BlackLevel < 0 \\ BlackLevel + ( \frac{( 1 - L , clamp ∈ [ 0 , ML ] )}{10} ) + & BlackLevel < - 5 \\ ( \frac{9 * ( 1 - L , clamp ∈ [ 0 , ML ] )}{50} * ( BlackLevel + 5 ) ) , & \\ L + ( \frac{L}{10} * BlackLevel ) , & BlackLevel > 0\end{matrix}$$

let LightnessAdjust clamp∈[0, 1]

$$BlackLevel ( {RGB}_{VideoLevel} , BlackLevel ) = \{ \begin{matrix}{RGB}_{VideoLevel} , & BlackLevel = 0 \\ HSVtoRGB ( HSLtoHSV ( [ H , S , LightnessAdjust ] ) ) , & BlackLevel \neq 0\end{matrix}$$

$$BlackLevel ( {RGB}_{VideoLevel} , BlackLevel ) = [ {R}_{BlackLevel} , {G}_{BlackLevel} , {B}_{BlackLevel} ] = {RGB}_{BlackLevel}$$

Equation 5: Hue [R_{BlackLevel}, G_{BlackLevel}, B_{BlackLevel}] to [R_{Hue}, G_{Hue}, B_{Hue}], described above as Hue Logic 310 (FIG. 3F).

The Hue adjustment applies the Unreal Engine's Material Function HueShift(Hue, RGB), where the hue shift function offsets the current hue value of an input color (RGB) by a given percentage. The percentage is 1-based and centered around the color wheel (such as described in https://dev.epicgames.com/documentation/en-us/unreal-engine/image-adjustment-material-functions-in-unreal-engine?application_version=5.2 #hueshift) to input texture, vector [R_{BlackLevel}, G_{BlackLevel}, B_{BlackLevel}], which is represented by RGB_{BlackLevel}.

For input parameter Hue in [−10, 10] from the UI, we scale to adjusted range [−0.5, 0.5] by dividing by 20, clamp to 25% of the complete color wheel by multiplying by 0.25, and apply the HueShift function.

$$let HueAdjust = ( \frac{Hue}{20} ) * 0.25$$

$$Hue ( {RGB}_{BlackLevel} , HueAdjust ) = HueShift ( HueAdjust , {RGB}_{BlackLevel} )$$

$$Hue ( {RGB}_{BlackLevel} , HueAdjust ) = [ {R}_{Hue} , {G}_{Hue} , {B}_{Hue} ] = {RGB}_{Hue}$$

With all five equations (Eq. 1, Eq. 2, Eq. 3, Eq. 4, Eq. 5) described above applied for color grading, chroma, video level, black level, and hue adjustments, the final color corrected texture RBGfinal or CC-RGB (color corrected RGB) is:

$${RGB}_{Final} = [ {R}_{Final} , {G}_{Final} , {B}_{Final} ] = [ {R}_{Hue} , {G}_{Hue} , {B}_{Hue} ]$$

Referring to FIG. 4A, a Color Correction Parameters Table 400 is shown, having parameters that may be set for performing the Color Correction Logic of FIG. 1A, as discussed herein. The table 400 includes Color Grading parameters and values for use in the Color Grating Logic 302, Chroma parameters and values for use in the Chroma Logic 304, VideoLevel parameters for use in the VideoLevel logic 306, BlackLevel parameters for use in the BlackLevel Logic 308, and Hue parameters for use in the Hue Logic 310.

Referring to FIG. 4B, a table 420 is shown which provides files for Virtual Sets, which may be selected using the UI dropdown menu for virtual sets. The Table 420 for the virtual set images, may be stored in the CC Server 26.

Referring to FIG. 4C, a table 430 is shown which provides files for Test Pattern images, which may be selected using the UI dropdown menu for test patterns. The Table 430 may be stored in the Test Pattern Server 38.

Referring to FIG. 4D, a table 440 is shown which provides files for Color Preset files, having UI default values for a given virtual screen image, which may be selected using a UI dropdown menu. The Table 440 may be stored in CC Server 26.

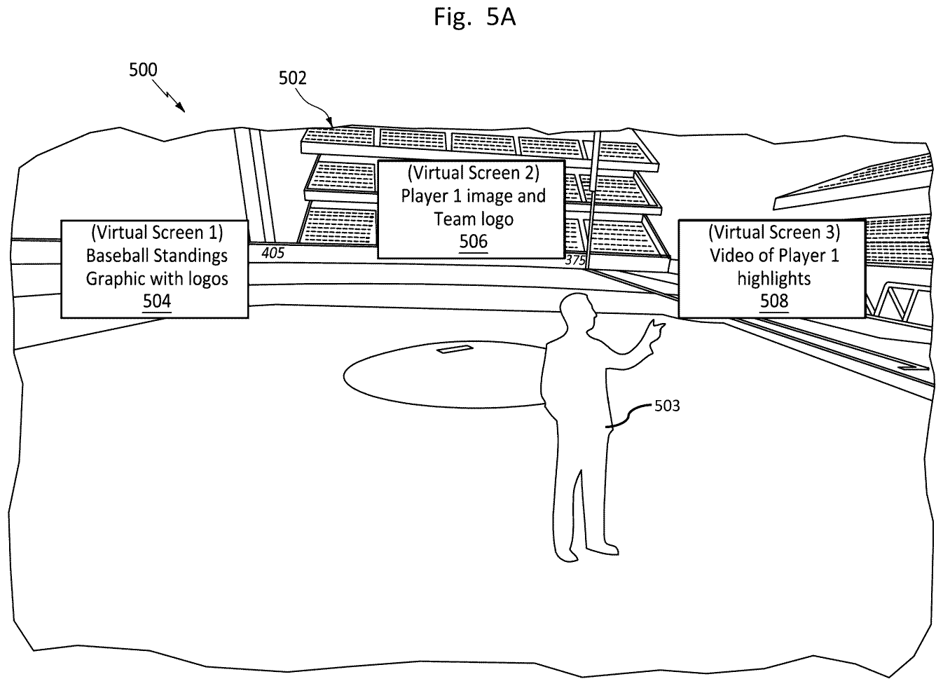

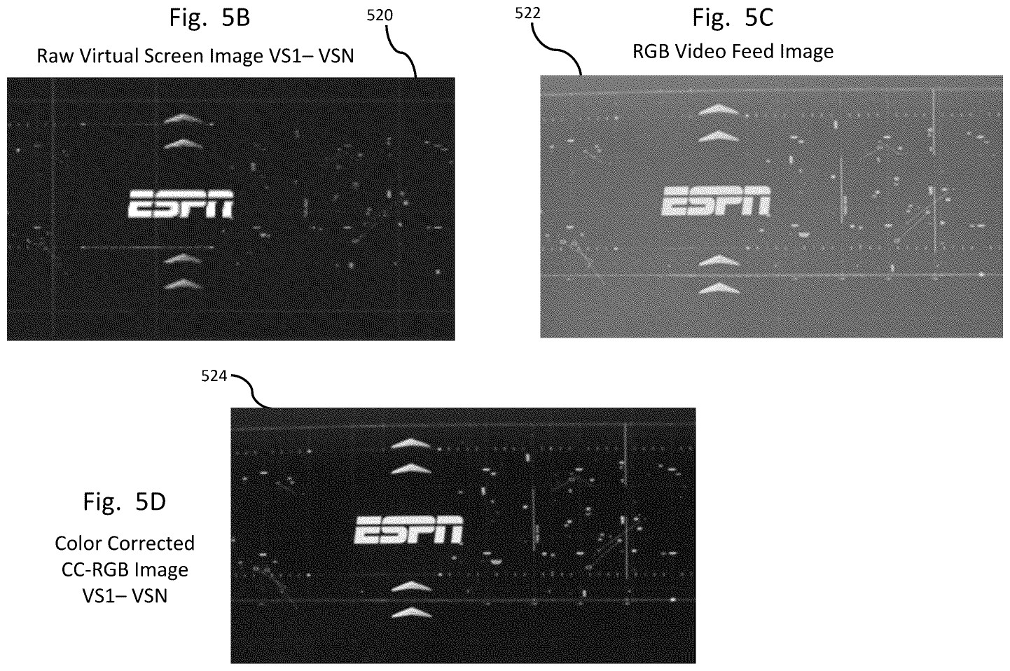

Referring to FIG. 5A, an illustration 500 of a broadcast image of a full virtual environment having a virtual baseball field set image 502 and three virtual screens/monitors 504,506,508, and a real person talent 503 providing commentary to the viewer and interacting with the virtual screens 504,506,508. In this example, the virtual screen 504 is displaying baseball standings data and associated team logos, the virtual screen 506 is displaying an image of baseball player Player 1 and his team logo, and the virtual screen 508 is showing a video of Player 1 play highlight.

In that case, the user/operator 18 (FIG. 1A) can view on the UI (FIG. 2A) the input or raw image of a selected one of the virtual screens (or virtual monitors) 504,506,508 (from the mixer 28 output or from the input to graphics engine 24), the non-color corrected output of the selected screen image from the graphics engine 22 (RGB Video Feed), and the broadcast image of the entire scene (Studio Video Out), and the user can perform color correction of images on the virtual screens 504,506,508 in real-time using the UI as discussed herein.

Referring to FIG. 5B, FIG. 5C, and FIG. 5D, color images of a ESPN logo is shown from three different points in the system 10, the raw virtual screen image (VS1-VSN) 520 from the mixer 28 (or graphics engine 24 input), the RGB video feed image 522 (of the non-color corrected output of the image from the graphics engine) 22, and the color corrected Color Corrected CC-RGB image (VS1-VSN) or the studio video output, respectively. As can be seen from the color images on the screens 520,522,524, the center image colors appear to be faded and washed-out and not matching the input image, for example, because the graphics engine provides general color correction for the virtual set image (i.e., the overall background scene), but not for content displayed on the virtual screens within the virtual set. The images for the virtual screens are received (or retrieved) from external sources and are typically different from the virtual set images, and thus likely have different color correction requirements or settings needed to make them appear as they should. However, the color corrected image on the screen 524 has colors that appear to match those of the input or raw image of the logo because they have been color corrected by the system of the present disclosure.

Referring to FIG. 6A, FIG. 6B, and FIG. 6C color images of image test patterns 602, 604, 606 are shown, in accordance with embodiments of the present disclosure. The image 602 in FIG. 6A shows a “Color Bars Rec. 709” test pattern having vertical color bars with a black bar at the bottom. The image 604 in FIG. 6B shows alternating vertical black bars with different colored small rectangles between the black vertical bars. The image 606 in FIG. 6C shows a “Grayscale Percent Ramp” test pattern having gray scale vertical bars ranging from black to white (left to right) on the top half and white to black (left to right) on the bottom half.

When the user/operator 18 (FIG. 1A) selects a test image from the UI (FIG. 2A), the selected test image appears in all three windows 202,204,206 of the UI from the three points in the system (mixer output/graphics engine input, graphics engine output, studio video out), which allows the user to perform color correction using the test pattern, in advance of displaying a virtual scene with virtual monitors. The user 18 can save for later use, e.g., in the CC Server 26, the color correction settings in the UI that worked best for the test patterns of interest.

Referring to FIG. 6D and FIG. 6E, luminance waveform monitor images 610A, 610B are shown of a gray scale test pattern, Grayscale Percent Ramp of FIG. 6A, before and after color correction, respectively, with an inset image 620A, 620B, respectively, of the studio output, in accordance with embodiments of the present disclosure. The vertical axis is in millivolts, ranging from 0 mV (for 0% luminance) to 700 mV (for 100% luminance), and the horizontal axis is in time, e.g., 1.5 microseconds per division.

Referring to FIG. 6D, the non-color-corrected image 610A has a step-wise graph 611A with an upward (or positive) slope portion 612A, and a downward (or negative) slope portion 616A. The two portions meet at point 614A, which is the center bar 607 of the test pattern 606 (FIG. 6C), where the upper and lower patterns have the same luminance. The graph 611A shows the luminance of a Studio video output image, shown as an inset image 620A, being viewed by the Waveform Monitor. Within the image 620A is at least one area (or virtual screen or monitor) 622A showing the output of the test image, based on a given set of color settings from the UI. The desired value for the center point (or 50%) value 614A is about 350 mV (of the full range of luminance 0 to 700 mV), shown by a horizontal dashed line 618. In this example, the UI color settings are shifted from the ideal luminance by a luminance error amount 619, which causes the resulting output luminance (or brightness) to not appear proper to the viewer, as can be seen on the virtual monitor 622A within the inset image 620A.

Referring to FIG. 6E, a color-corrected waveform monitor image 610B has a step-wise graph 611B with an upward (or positive) slope portion 612B, and a downward (or negative) slope portion 616B. The graph 611B is similar to the graph 611A of FIG. 6D, except the graph center point 614B has been shifted down to be substantially at the 50% line 618, based on adjusted UI color control parameters from those of FIG. 6D. In this case, the inset image 620B shows a display screen 622B, based on the adjusted color settings from the UI. This results in no luminance error, and the image luminance (or brightness) will appear correct to the viewer, as can be seen on the virtual monitor 622B within the inset image 620B.

Referring to FIG. 6F and FIG. 6G, color vector scope (or vector display) images 650A, 650B (showing color and color intensity) are shown of a color bar test pattern, e.g., the Color Bars Rec. 709 test pattern of FIG. 6C, before and after color correction, respectively, with an inset (or thumbnail) image 680A, 680B, respectively, of the studio video output, in accordance with embodiments of the present disclosure. The vectorscope image, as is known, is a circular graphical image having vertical axis labeled r-y and a horizontal axis labeled b-y, and having colors (going counterclockwise) of Red (R), Yellow (Yl), Green (G), Cyan (Cy), Blue (B). and Magenta (Mg). For each color there is a desired or target box 662, 663, 664, 665, 666, 667, respectively, and each box having a center box 672,673,674,675,676,677, respectively, where each of the colors in the graphs should ideally reside.

Referring to FIG. 6F, the non color-corrected image 650A has a star-shaped graph 651A with 6 points 652A, 653A, 654A, 655A, 656A, 657A, corresponding to the 6 colors (going counterclockwise from r-y axis) of Red (R), Yellow (YI), Green (G), Cyan (Cy), Blue (B). and Magenta (Mg), respectively. Each of the points 652A, 653A, 654A, 655A, 656A, 657A is outside the corresponding target center box 672,673,674, 675,676,677, respectively. Also, each of the points 652A, 653A, 654A, 655A, 656A, 657A is outside the corresponding target box 662, 663, 664, 665, 666, 667, respectively. Within the image 680A is at least one area (or virtual screen or monitor) 682A showing the output of the test image, based on a given set of color settings from the UI. In this example, the UI color settings are shifted from the ideal color for each of the colors, which causes the resulting output color to not appear proper to the viewer, as can be seen on the virtual monitor 682A within the inset image 680A.

Referring to FIG. 6G, a color-corrected vectorscope (or vector display) image 650B has a star-shaped graph 651A with 6 points 652B, 653B, 654B, 655B, 656B, 657B, corresponding to the 6 colors (going counterclockwise from r-y axis) of Red (R), Yellow (YI), Green (G), Cyan (Cy), Blue (B). and Magenta (Mg), respectively. The graph 651B is similar to the graph 651A of FIG. 6F, except the that each of the points of the graph has been shifted to be within the target box and within or close to the center target box, based on adjusted UI color control parameters from those of FIG. 6F. In this case, the inset image 680B shows a virtual screen 682B based on the adjusted color settings from the UI. This results in no or minimum color error, and the color will appear correct to the viewer, as can be seen on the virtual monitor 682B within the inset image 680B.

The waveform monitor images and vectorscope (or Vector display) images shown herein with FIGS. 6D-6F were obtained with a Techtronix WFM 5250 waveform monitor. Other waveform monitors or vectorscopes may be used if desired.

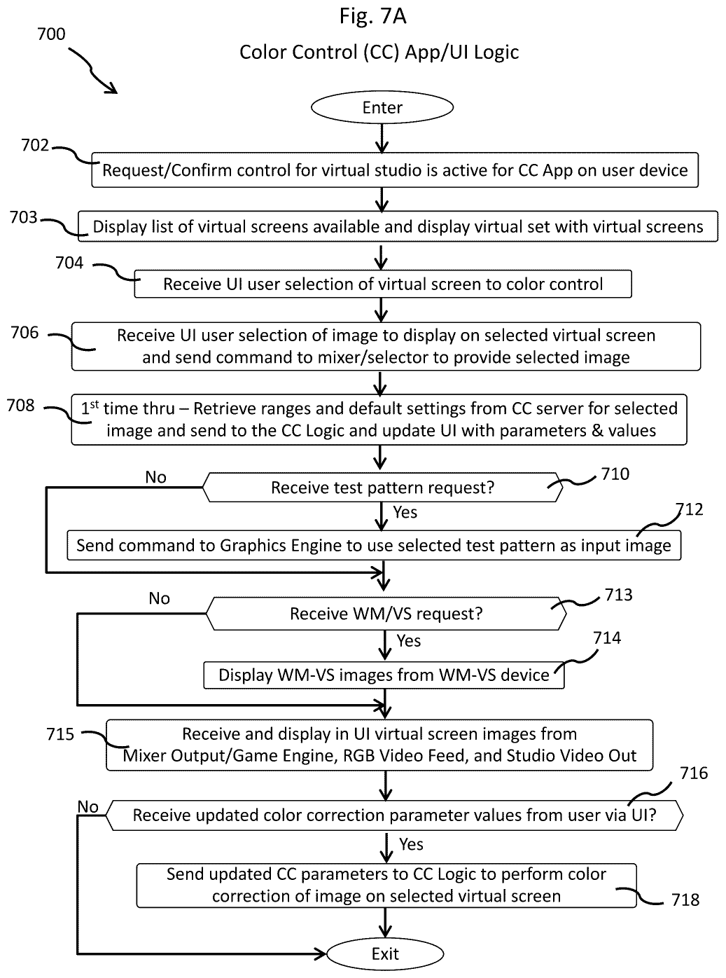

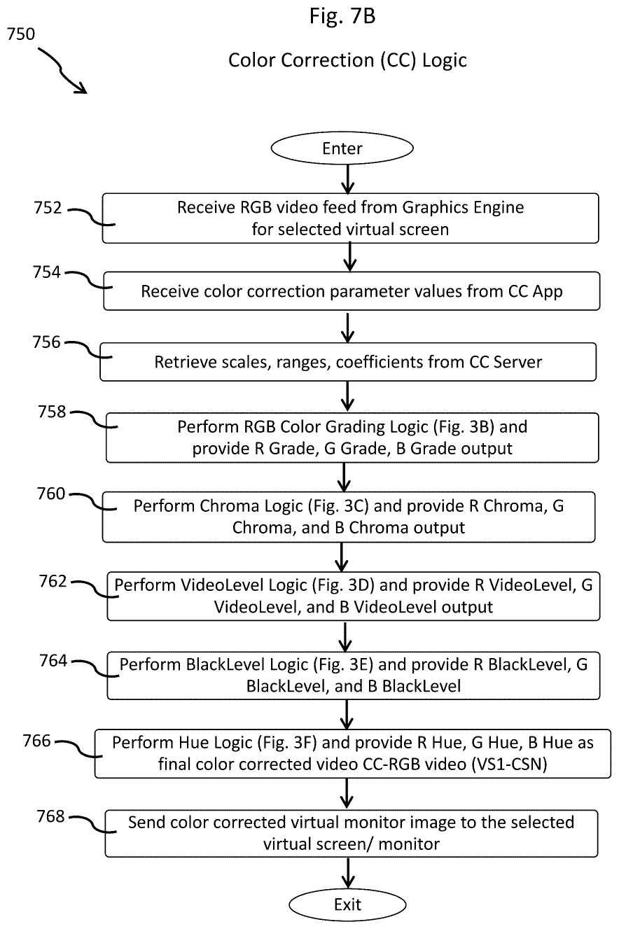

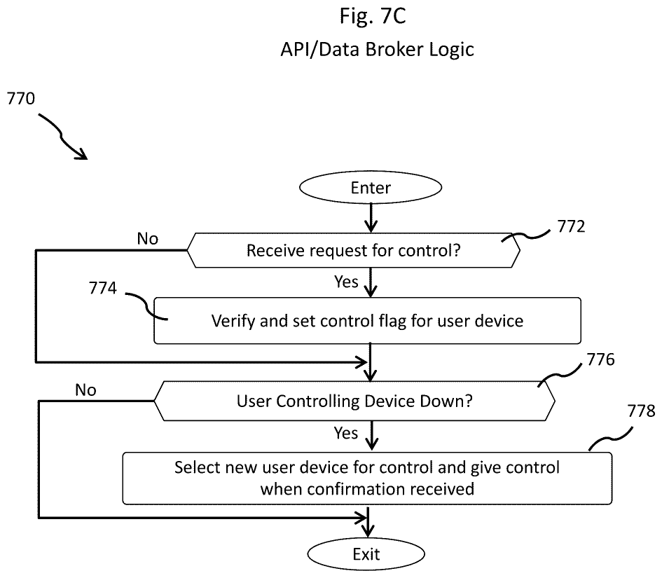

Referring to FIG. 7A, a flow diagram 700 illustrates one embodiment of a process or logic for implementing the Color Correction (CC) App/UI Logic (per user) (FIG. 1A), in accordance with embodiments of the present disclosure. The process 700 begins at block 702, which requests/confirms control is active for CC App on the user device 12. Next, block 703 displays a list of virtual screens available for the virtual studio. Next, block 704 receives UI user selection of the virtual screen to color control (or color correct). Next, block 706 receives UI user (or operator) 18 (FIG. 1A) selection of the image to display on the selected virtual screen and sends the appropriate commands to the mixer/selector 28 to provide the selected image for the selected virtual screen to the graphics engine 22. Next, block 708, for first time through for the selected screen, retrieves ranges and default settings from CC server 26 (or the Graphics Engine 22) for the selected image and sends same to the CC Logic 20 and updates the UI with corresponding parameters and values selected by the user/operator. Next, block 710 determines whether a test pattern request has been received. If Yes, block 712 sends command to the Graphics Engine to use a selected test pattern as the input image for the selected virtual screen. Next, block 713 determines whether a waveform monitor/vectorscope (WM-VS) request has been received from the user. If Yes, block 714 receives the video image signal from the WM-VS device 54A, which provides WM-VS images of the virtual studio associated with the selected virtual screen and displays them in the waveform monitor & vector scope (WM-S_{V}) UI display window 207. Next, or if the result of block 713 is No, block 715 receives the virtual screen images from the Mixer Output/Game Engine, CC Logic, and Studio Video Out, and displays them in the corresponding three UI display windows 202,204,206. Next, block 716 determines whether updated color correction parameter values have been received from user via the UI. If Yes, block 718 sends updated CC parameters to CC Logic to perform color correction of selected virtual screen. Next, or If the result of block 716 is NO, the logic exits.

Referring to FIG. 7B, a flow diagram 750 illustrates one embodiment of a process or logic for implementing the Color Correction (CC) Logic (FIG. 1A), in accordance with embodiments of the present disclosure. The process 750 begins at block 752, which receives the RGB video feed from the Graphics Processing Logic 24 (within the Graphics Engine 22) for the selected virtual screen. Next, block 754 receives the color correction parameter values from CC App, which were received from the user 18. Next, block 756 retrieves scales, ranges, coefficients, and the like, from the CC Server 26 to perform the necessary calculations to perform color correction. Next, block 758 performs RGB Color Grading Logic (FIG. 3B) and provides R Grade, G Grade, B Grade output to the Chroma Logic. Next, block 760 performs the Chroma Logic (FIG. 3C) and provides R Chroma, G Chroma, and B Chroma output to the VideoLevel Logic. Next, block 762 performs the VideoLevel Logic (FIG. 3D) and provides R VideoLevel, G VideoLevel, and B VideoLevel output to the BlackLevel Logic. Next, block 764 performs BlackLevel Logic (FIG. 3E) and provides R BlackLevel, G BlackLevel, and B BlackLevel to the Hue Logic. Next, block 764 performs the Hue Logic (FIG. 3F) and provides R Hue, G Hue, B Hue as final color corrected video CC-RGB video (VS1-CSN). Next, block 768 sends color corrected virtual monitor image to the selected virtual screen/monitor and the logic exits.

Referring to FIG. 7C, a flow diagram 770 illustrates one embodiment of a process or logic for implementing the API/Data Broker Logic (FIG. 1C), in accordance with embodiments of the present disclosure. The process 770 begins at block 772, which determines whether a request for control has been received. If Yes, block 774 verifies the user device and sets the control flag for the requesting user device. Next, or if the result of block 772 is No, block 776 determines whether there is user controlling device down (e.g., power outage or equipment failure). If Yes, block 778 selects a new user device for control and gives control to new user device when confirmation is received from new user device. Next, or if the result of block 776 is No, the logic exits.

Referring to FIG. 8, the present disclosure may be implemented in a network environment 80. In particular, various components of an embodiment of the system of the present disclosure include a plurality of computer-based user devices 12 (e.g., Device 1 to Device N), which may interact with respective users (User 1 to User N). A given user may be associated with one or more of the devices 12. In some embodiments, the CC App 16 may reside on the user device 12 or on a remote server and communicate with the user device(s) 12 via the network. In particular, one or more of the user devices 12, may be connected to or communicate with each other through a communications network 70, such as a local area network (LAN), wide area network (WAN), virtual private network (VPN), peer-to-peer network, or the internet, wired or wireless, as indicated by lines 72, by sending and receiving digital data over the communications network 70. If the user devices 12 are connected via a local or private or secured network, the user devices 12 may have a separate network connection to the internet (or other network) for use by web browsers running on the devices 12. The user devices 12 may also each have a web browser 17 to connect to or communicate with the internet to obtain desired content in a standard client-server based configuration to obtain the CC App 16 or other needed files to execute the logic of the present disclosure. The user devices 12 may also have local digital storage located in the device itself (or connected directly thereto, such as an external USB connected hard drive, thumb drive or the like) for storing data, images, audio/video, documents, and the like, which may be accessed by the CC App 16 running on the user devices 12.

Also, the computer-based user devices 12 may also communicate with separate computer servers via the network 70 for the CC Server 26, Test Pattern Server 38, Virtual Sets Server 42, and the Other/API Servers 76. The servers 26,42,38,76 may be any type of computer server with the necessary software or hardware (including storage capability) for performing the functions described herein. Also, the servers 26,42,38,76 (or the functions performed thereby) may be located, individually or collectively, in one or more separate server(s) on the network 70, or may be located, in whole or in part, within one (or more) of the user devices 12 on the network 70. In addition, the user devices 12, may each communicate via the network 70 with the CC Server 26 and the Other/API Servers 76, and with each other or any other network-enabled devices or logics as needed, to provide the functions described herein. Similarly, the user devices 12 may each also communicate via the network 70 with the logics or software applications described herein, and any other network-enabled devices/logics necessary to perform the functions described herein.

Portions of the present disclosure shown herein as being implemented outside the user device 12, may be implemented within the user device 12 by adding software or logic to the user devices 12, such as adding logic to the CC App software or installing a new/additional application software, firmware or hardware to perform some of the functions described herein, or other functions, logics, or processes described herein.

The system, computers, servers, devices and the like described herein have the necessary electronics, computer processing power, interfaces, memory, hardware, software, firmware, logic/state machines, databases, microprocessors, communication links, displays or other visual or audio user interfaces, printing devices, and any other input/output interfaces, to provide the functions or achieve the results described herein. Except as otherwise explicitly or implicitly indicated herein, process or method steps described herein may be implemented within software modules (or computer programs) executed on one or more general purpose computers. Specially designed hardware may alternatively be used to perform certain operations. Accordingly, any of the methods described herein may be performed by hardware, software, or any combination of these approaches. In addition, a computer-readable storage medium may store thereon instructions that when executed by a machine (such as a computer) result in performance according to any of the embodiments described herein.

In addition, computers or computer-based devices described herein may include any number of computing devices capable of performing the functions described herein, including but not limited to: tablets, laptop computers, desktop computers, smartphones, smart TVs, set-top boxes, e-readers/players, and the like.

Although the disclosure has been described herein using exemplary techniques, algorithms, or processes for implementing the present disclosure, it should be understood by those skilled in the art that other techniques, algorithms and processes or other combinations and sequences of the techniques, algorithms and processes described herein may be used or performed that achieve the same function(s) and result(s) described herein and which are included within the scope of the present disclosure.

Any process descriptions, steps, or blocks in process or logic flow diagrams provided herein indicate one potential implementation, do not imply a fixed order, and alternate implementations are included within the scope of the preferred embodiments of the systems and methods described herein in which functions or steps may be deleted or performed out of order from that shown or discussed, including substantially concurrently or in reverse order, depending on the functionality involved, as would be understood by those reasonably skilled in the art.

It should be understood that, unless otherwise explicitly or implicitly indicated herein, any of the features, characteristics, alternatives or modifications described regarding a particular embodiment herein may also be applied, used, or incorporated with any other embodiment described herein. Also, the drawings herein are not drawn to scale, unless indicated otherwise.

Conditional language, such as, among others, “can,” “could,” “might,” or “may,” unless specifically stated otherwise, or otherwise understood within the context as used, is generally intended to convey that certain embodiments could include, but do not require, certain features, elements, or steps. Thus, such conditional language is not generally intended to imply that features, elements, or steps are in any way required for one or more embodiments or that one or more embodiments necessarily include logic for deciding, with or without user input or prompting, whether these features, elements, or steps are included or are to be performed in any particular embodiment.

Although the invention has been described and illustrated with respect to exemplary embodiments thereof, the foregoing and various other additions and omissions may be made therein and thereto without departing from the spirit and scope of the present disclosure.

What is claimed is:

1. A computer-based method for performing color correction of at least one virtual screen image displayed on a portion of a virtual background scene image in a virtual studio separately from any alteration of the color of the virtual background scene, comprising:
providing an RGB virtual screen image having RGB components with RGB component values;
displaying on a user device, a plurality of selectable color correction parameters and a range of values for each of the selectable color correction parameters, and at least one selectable virtual screen image corresponding to the color correction parameters;
receiving from a user a selection of a value for at least one of the selectable color correction parameters corresponding to a selected virtual screen image as selected color correction parameter values, the selected color correction parameter values comprising at least one of white (gain), black (lift), gamma, chroma, videolevel, blacklevel, and hue;
adjusting the values of the RGB components of the RGB virtual screen image based on the selected color correction parameter values as a color corrected virtual screen image; and
sending the color adjusted virtual screen image to the virtual studio for display as the virtual screen image.

2. The method of claim 1 wherein the RGB virtual screen image is provided by a graphics engine or a game engine.

3. The method of claim 1 wherein the virtual background scene image is provided by a graphics engine or a game engine.

4. The method of claim 1 further comprising receiving a studio output video signal at the user device from a video camera viewing the virtual LED studio, the studio output video having the virtual background scene and the at least one virtual screen.

5. The method of claim 1 further comprising receiving at least one virtual screen source image at the user device to be used for the at least one virtual screen image.

6. The method of claim 1 wherein the virtual screen source image comprises at least one of live video and recorded video.

7. The method of claim 1 further comprising displaying a plurality of virtual test patterns to be displayed in the virtual studio and selecting a virtual test pattern image from the plurality of virtual test pattern images as a selected virtual test pattern image to be displayed on the selected virtual screen in the virtual studio.

8. The method of claim 1 further comprising displaying a plurality of virtual screens to be displayed in the virtual studio and selecting a virtual screen from the plurality of virtual screens as a selected virtual screen to be color corrected by the user.

9. The method of claim 1 further comprising displaying a plurality of virtual screen source images to be displayed on the selected virtual screen in the virtual studio and selecting a virtual screen source image from the plurality of virtual source images as a selected virtual source image to be displayed on the selected virtual screen in the virtual studio.

10. The method of claim 1 further comprising receiving a waveform image signal from a waveform monitor or vectorscope at the user device and displaying the waveform image signal by the user device when selected by the user.

11. The method of claim 1 wherein the virtual studio comprises at least one of: an LED-based virtual studio and a projection-based virtual studio.

12. The method of claim 1 wherein there is a plurality of user devices, one device being in control of the virtual studio at any given time.

13. The method of claim 1 wherein adjusting the values of the RGB components of the RGB virtual screen image comprises calculating an adjustment to the RGB components and adjusting the RGB components by such adjustment.

14. The method of claim 1 wherein the adjusting the values of the RGB components of the RGB virtual screen image comprises calculating at least one of color grade adjustment, a chroma adjustment, a videolevel adjustment, a blacklevel adjustment, and a hue adjustment based on the selected color correction parameter values.

15. The method of claim 1 wherein the virtual studio comprises at least one of an LED volume, a rear projection system, and a front projection system.

16. The method of claim 1 further comprising providing a plurality of user devices capable of performing the adjusting, and selecting a user device to be in control of the virtual studio.

17. A computer-based method for performing color correction of at least one virtual screen image displayed on a portion of a virtual background scene image in a virtual studio, comprising:
providing an RGB virtual screen image having RGB components with RGB component values;
displaying on a user device, a plurality of selectable color correction parameters and a range of values for each of the selectable color correction parameters, and at least one selectable virtual screen image corresponding to the color correction parameters;
receiving from a user a selection of a value for at least one of the selectable color correction parameters corresponding to a selected virtual screen image as selected color correction parameter values, the selected color correction parameter values comprising white (gain), black (lift), gamma, chroma, videolevel, blacklevel, and hue;
such color correction parameters adjusting only the selected virtual screen image in the virtual studio and does not change the remaining portions of the virtual scene image;
adjusting the values of the RGB components of the RGB virtual screen image based on the selected color correction parameter values as a color corrected virtual screen image; and
sending the color adjusted virtual screen image to the virtual studio for display as the virtual screen image in the virtual studio.

18. The method of claim 17 wherein the RGB virtual screen image is provided by a graphics engine or a game engine.

19. The method of claim 17 further comprising receiving a studio output video signal at the user device from a video camera viewing the virtual studio, the studio output video having the virtual background scene and the at least one virtual screen.

20. The method of claim 17 further comprising receiving at least one virtual screen source image at the user device to be used for the at least one virtual screen image.

21. The method of claim 17 further comprising displaying plurality of virtual screens to be displayed in the virtual studio and receiving a selection by the user of a virtual screen from the plurality of virtual screens as a selected virtual screen to be color corrected by the user.

22. The method of claim 17 wherein there is a plurality of user devices, one device being in control of the virtual studio at any given time.

23. The method of claim 17 wherein the adjusting the values of the RGB components of the RGB virtual screen image comprises calculating a color grade adjustment, a chroma adjustment, a videolevel adjustment, a blacklevel adjustment, and a hue adjustment based on the selected color correction parameter values.

24. A computer-based method for performing color correction of at least one virtual screen image displayed on a portion of a virtual background scene image in a virtual studio while not altering the color of the virtual background scene, comprising:
providing an RGB virtual screen image having RGB components with RGB component values;
displaying on a user device, a plurality of selectable color correction parameters and a range of values for each of the selectable color correction parameters, and at least one selectable virtual screen image corresponding to the color correction parameters;
receiving from a user a selection of a value for at least one of the selectable color correction parameters corresponding to a selected virtual screen image as selected color correction parameter values;
adjusting the values of the RGB components of the RGB virtual screen image based on the selected color correction parameter values as a color corrected virtual screen image; and
sending the color adjusted virtual screen image to the virtual studio for display as the virtual screen image.

25. The method of claim 24 wherein the selected color correction parameter values comprises at least one of: white (gain), black (lift), gamma, chroma, videolevel, blacklevel, and hue; and wherein the adjusting the values of the RGB components of the RGB virtual screen image comprises calculating a color grade adjustment, a chroma adjustment, a videolevel adjustment, a blacklevel adjustment, and a hue adjustment based on the selected color correction parameter values.
